(19) United States
(12) Patent Application Publication
(10) Pub. No.: US 2002/0032640 A1
(43) Pub. Date: Mar. 14, 2002

(54) Data processing system and method for managing broker transaction information

(76) Inventors: David W. LaFore, Littleton, CA (US); Kyle L. Brennan, Aurora, CO (US)

Correspondence Address: Brent P. Johnson, SHERIDAN ROSS P.C., Suite 1200, 1560 Broadway, Denver, CO, 80202-5141, US

(21) Appl. No.: 09/853,986

(22) Filed: May 11, 2001

Related U.S. Application Data
(63) Continuation-in-part of application No. 09/497,272, filed on Feb. 3, 2000.

(51) Int. Cl. G06F 17/60

(52) U.S. Cl. 705/37; 705/36

(57) ABSTRACT

A data processing system and method manages broker transaction information in compliance with Securities Exchange Commission record keeping requirements utilizing electronic data transmission, thus eliminating problems associated with paper logs, or easily alterable databases. In a first embodiment, data is entered into the system through remote client workstations, stored in local tables until the user performs a data transmission function to a central database server. In a second embodiment, a web server hosts a website accessible by users and data is entered by logging onto the website and then executing desired data entry functions. The data is stored in the main database server enabling multiple off-site users to view and/or modify data and generate the necessary reports. The data processing system transmits data via a secured environment through encryption/decryption. The data processing system produces an electronic audit trail of modifications made to the recorded data. Security measures are provided to prevent unauthorized tampering of trade records.

### CROSS REFERENCE TO RELATED APPLICATIONS

This application is a continuation-in-part of co-pending U.S. patent application Ser. No. 09/497,272 filed Feb. 3, 2000 entitled “Data Processing System And Method For Managing Broker Transaction Information,” further identified as Attorney Docket No. 7103-1.

### I. TECHNICAL FIELD

The present invention relates to a data processing system and method for managing broker transaction information and, more particularly, to a data processing system and method of electronically processing data for all types of broker-related activities to include stock broker transactions, management of client information, and generation of reports in compliance with the requirements of the Securities and Exchange Commission (SEC).

### II. BACKGROUND OF THE INVENTION

Section 17(a)(1) of the Securities Exchange Act of 1934 (“Exchange Act”) requires registered broker dealers to make, keep, furnish and disseminate records and reports prescribed by the SEC “as necessary or appropriate in the public interest, for the protection of investors, or otherwise in the furtherance of the purposes of the Exchange Act.” Rules 17(a)(3) and 17(a)(4) of the Exchange Act specify minimum requirements with respect to the records that broker-dealers must keep, as well as the periods during which those records and other documents relating to the broker-dealers' business must be preserved. The SEC, self-regulatory organizations (“SROs”), and state securities regulators must have timely access to these records to conduct effective examinations involving broker enforcement actions.

Rule 17(a)(3) requires broker-dealers to generate local office blotters, record supplemental information on brokerage order memoranda, create customer account forms, and maintain additional records concerning associated persons, customer complaints, and exceptional activity in customer accounts. Furthermore, the rule requires that broker-dealers designate a principal to be responsible for books and records compliance, and requires broker-dealers to make certain records available to each of their local offices. The rules are even requiring the monitoring and reporting of electronic mail (e-mail) correspondence to and from a broker.

Broker-dealers adhere to the rules stated above, using paper blotters generated by hand on paper, or using “off-the-shelf” database management or spreadsheet programs. There are no industry standards for keeping these local office blotters. Since the type of blotters kept at each local office within the same broker-dealer branch may vary greatly, examination by the SEC, SROs, state regulators and broker-dealer compliance personnel is difficult and time-consuming.

State securities regulators more often than not are the authorities that have the most contact with the local broker offices. They are, however, prohibited under the National Securities Market Improvement Act of 1996 (“NSMIA”) from requiring the establishment of books and records rules that differ from, or are in addition to, the SEC's rules. NSMIA also provides that the SEC must consult periodically with state securities regulators concerning the adequacy of the SEC's books and records rules.

All trades of securities are required to be approved or disapproved by the local broker office principal. In local offices where the broker-dealer representatives are located in the same office as the principal, this approved process can be performed on a timely basis. However, in instances where the broker representatives are located outside of the principal's office, the broker representatives must, on a timely basis, either by mail or courier, deliver to the principal all trades for review. While this process may ensure timely processing of the broker representatives' prospective trades, utilization of overnight mail and/or courier services can be time consuming and expensive. Sometimes, however, critical trades are not made in a timely fashion because of the time it takes to process approval of the trade through mail or courier service.

While the SEC rules are helpful in protecting investors and allow for information dissemination which assists in better understanding by the industry and the regulators, these rules create significant cost and time issues at the local broker office level. Although the current system of recording trade information by hand or using off-the-shelf database management tools has worked in the past, it is evident that there is a need for a comprehensive data processing system to assist broker-dealers, broker representatives, local offices and regulators in dealing with the rules.

Thus, a comprehensive data processing system is needed to address the following issues: (i) current methods are too costly and time consuming, (ii) a system is needed which would allow office principals to approve trades on a more expedient basis, particularly for those instances where the broker representatives are located outside of the principal's office, (iii) a system is needed which allows regulators to make more efficient and comprehensive inspections by creation of standardized reports which can be instantaneously accessed during an inspection, (iv) a system is needed for broker representatives to be able to view books and records on a more timely basis to better serve their clients, and to better communicate with broker office principals, (v) an electronic audit trail is needed to provide security measures which help to prevent unauthorized tampering of records, and which flag any unauthorized access and use of data in the data processing system, and (vi) a system is needed to handle e-mail communications involving broker transactions.

### III. SUMMARY OF THE INVENTION

The present invention relates to a data processing system and method for managing broker transaction information in compliance with governmental regulations. The data processing system further provides for managing other types of broker transaction information such as client profiles, and for providing security measures which enhance the ability to prevent unauthorized trade activities.

The data processing system allows for secure input, data transfer and storage of a wide array of information. The input, data exchange and storage of the data is achieved by electronic data transmission, thus eliminating the need for paper logs. In a first embodiment of the invention, as further discussed below, means for processing data is provided which includes computer software installed at various locations within the data processing system. In a second embodiment of the invention, the data processing system has means for processing data which is installed on a web server computer; therefore, there is but one necessary installation of the means for processing data, and users log on to a website and conduct functions within the data processing system through the web server. The first embodiment can also be referred to as a Windows™ version, and the second embodiment can be referred to as a web browser version. The functionality of both embodiments is essentially the same; however, the second embodiment or the web browser version may incorporate some additional enhancements, as further discussed below. The data processing system in both embodiments utilizes a secure environment to transmit all data through encryption/decryption. The data processing system further provides for an audit trail of modifications made to the recorded data. A hierarchy of user levels is established within the data processing system which provides additional security measures to prevent unauthorized tampering of data, and to further validate the electronic audit trail.

The data processing system for both embodiments includes computer processing means for processing data, storage means for storing data on a storage medium, and communication means for transferring data in a secure environment. The first embodiment can be conceptually broken down into five main components or groupings of the data processing system which allow the data processing system to achieve its functionality. They are as follows: (1) the main server database and the Transmission Control Protocol (TCP) Listener. The main server database acts as the central repository for data entered into the system. The main server database is monitored and updated based upon commands executed or facilitated by the TCP Listener, which has a permanent connection to a worldwide means of communications, such as the worldwide web of global communication networks (often referred to as the “Internet”); (2) a first means for processing data or computer software means in the form of coded computer instructions which enable data such as trade record data and supporting client information data to be entered for each client account. The first software means also functions to enable client and trade record data to be forwarded to the main server database for storage and subsequent retrieval by the appropriate branch manager and/or regional compliance director. Each installation of the first software means creates and maintains its own local database, and is identified within the system by a unique system identification code. This first software means may also be referred to as the “broker representatives' version.” This first software means can be installed on a single work station in the form of a personal computer, or on a multi-user system within a local area network (“LAN”). This first software means also has functionality for the output of data in the form of reports required by the SEC, and further allows for other types of data output to include an electronic audit trail of modifications made to all recorded data. The first software means also allows for the broker trade information to be handled by electronic mail (e-mail); (3) a second means for processing data or computer software means is provided which is similar to the broker representative's version, but has limited functionality. This second software means allows a user, such as a branch manager, to retrieve client and trade information from the main server database, and to approve or reject trade records generated by various broker representatives. This second software means also allows the user to view all trades for any and all broker representatives within that branch manager's branch office. This software is installed as a single user stand alone system with its own database, and may be referred to as the “branch manager's version”. Like the broker representative's version, the branch manager's version can also handle electronic mail transactions; (4) a third data processing means or computer software means for security purposes is provided which establishes the authorized levels of use in the data processing system, such as the adding or updating of user names and passwords throughout the system. This third software means also handles other requirements to include common administrator functions. This software simply communicates with the main server database, and does not have its own database. This software is referred to as the “DBMS Administrator” or “administrator;” and (5) the last component of the system includes yet another data processing means or computer software means, also referred to as the “regional compliance director's version.” This version of software enables a user, such as a regional compliance director, to connect to the main server to review trade records for one or more branches at one time. Like the branch manager's version, this software does not allow updates or entry of client or trade records. This software is installed as a single user stand alone system, and does not have its own database.

Thus, for the first embodiment on the Windows™ version, the data is entered on remote work stations, stored in local databases until the user performs a data transmission function which electronically transfers the data to a central database. The central database acts as a central repository enabling multiple off-site users to view and/or modify data, and generate reports or output which may be required by the SEC.

For the second embodiment or the web browser version, it can be conceptually broken down into two main components or groupings that allows the data processing system to achieve its functionality. They are as follows: (1) a main database that acts as the central repository for data entered into the system and (2) a means for processing data or computer software means in the form of coded computer instructions. In terms of comparing the components of the first and second embodiments, the single computer software means in the second embodiment corresponds to the first, second and third data processing means of the first embodiment, and also has similar functionality as the TCP listener and the regional compliance directors version. For the web browser version, it is unnecessary to have the different installations of the computer software because the web server computer has the entire means for processing loaded thereon. The user in the web browser version logs on to the website and then performs desired functions based upon functions made available to the type of user. There are two ways in which data is entered through the browser version: (1) through a website and transmitted via a LAN or the worldwide web to the web server. The web server then forwards the data to the database; or (2) through a data feed from a separate third party electronic online trading system and transmitted via a LAN or the worldwide web to the web server or an FTP server. The web server or FTP server then forwards the data to the main database. Transmission of data in the second embodiment via the worldwide web or LAN is also secure utilizing data encryption/decryption provided by SSL. Other than consolidation of the means for processing data at the web server computer, and the manner in which data is entered and retrieved through a website, the first and second embodiments have the same functionality, except for those additional features discussed below with respect to the second embodiment.

In summary, the data processing system provides electronic means for recording and monitoring all stockbroker transaction information. The data processing system maintains records on client information such as names, addresses, types of investments, trade activity, funds availability, investment objectives, as further discussed below. In addition, the data processing system generates reports on daily trade activity, production/activity by stock broker, activity by client and by almost any other category which has been designated a data field within the data processing system.

Some specific functional aspects of the data processing system of this invention include the ability to monitor and record any and all data changes made to previously entered trade records. This audit function prevents the changing of any trade record data without some record being made thereof in the main database. This is an additional security feature which further ensures that all data is entered and recorded, whether it be the entry of original data for a trade transaction, or necessary changes which sometimes need to be made to trade data. A trade audit report may be generated which shows a change status with regard to each trade record.

Another specific functional feature of the data processing system of this invention includes recordation of all log-ins in the form of a log-in report which records the specific user and time at which the user made an attempt, or actually accessed the data processing system of this invention. From this log-in report, security information can be maintained which may indicate whether an unauthorized user made, or attempted to make, entry into the data processing system. Yet another specific functional feature of the data processing system of this invention includes recordation and processing of all e-mail messages. In addition to the traditional means of communication which are monitored by the SEC, e-mail is also now a means of communication which is strictly monitored by the SEC. Accordingly, the data processing system of this invention addresses this need for monitoring and recording all electronic mail transactions by providing means by which there is complete recordation and tracking of electronic mail to and from a broker representative and client.

The data processing system and method of the invention results in a comprehensive means to assist broker/dealer representatives, local brokerage offices, and government regulators in dealing not only with SEC rules, but to better record and track all operations of a brokerage. Other objects and embodiments of the invention, its nature and various advantages will be apparent to those skilled in the art from the accompanying figures and the following detailed description of the invention.

### IV. BRIEF DESCRIPTION OF THE FIGURES

FIGS. 1-59 specifically disclose the first embodiment. FIGS. 60-66 specifically disclose certain features of the second embodiment. It shall be understood that unless otherwise specifically mentioned, the functionality illustrated and discussed in detail with respect to the first embodiment also applies to the second embodiment.

FIG. 1 is a schematic diagram illustrating the major components of the data processing system, and the flow of information within the data processing system according to the present invention;

FIGS. 2A-2E illustrate pull down menus corresponding to a main menu bar which are displayed on a user interface screen or display of a computer in the data processing system;

FIG. 3 includes a series of flow diagrams illustrating the setup process for initializing the data processing system to accept and process data;

FIG. 4 is a flow diagram illustrating how trade information is recorded on the main server database;

FIG. 5 is a flow diagram generally illustrating data transfer within the data processing system;

FIG. 6 is a flow diagram illustrating the flow of data for the broker representative's version;

FIG. 7 is a flow diagram illustrating the flow of data for the branch manager's version;

FIG. 8 is a flow diagram illustrating the flow of data for the regional compliance director's version;

FIGS. 9-15 illustrate user interface or screen displays which are viewed on a computer terminal and show the manner in which, and the type of data which may be entered in the data processing system;

FIG. 16 illustrates a user interface or screen display which activates data transfer in the broker representative's version to and from the main database;

FIG. 17 illustrates a user interface screen or display showing an output in the form of a report of trade summary information which can display trade data according to desired data fields;

FIG. 18 illustrates an output in the form of a daily trade blotter report required by the SEC;

FIG. 19 illustrates a user interface screen or display of the means by which a user can select the output of data for selected time periods of the daily trade blotter.

FIGS. 20-23 illustrate additional outputs which may be created by the data processing system in the form of other reports which may be required by the SEC;

FIGS. 24 and 25 illustrate user interface screens or displays used to enter data regarding clients and broker representatives, respectively;

FIG. 26 illustrates a user interface screen or display used to enter data regarding user identification, and authorized levels of use of a particular user;

FIG. 27 illustrates an output in the form of a report which is an audit trail of modifications made to a particular trade record which has been previously created and stored in the main server database;

FIG. 28 illustrates a user interface screen which allows a user to select the output of data in the audit trail report based upon a selected broker representative, branch, and time period;

FIG. 29 shows another output in the form of a log-in report which indicates all users who have logged in or who have made an attempt to log into the data processing system;

FIG. 30 illustrates a user interface screen or display which allows a user to select the output of data in the log-in report;

FIG. 31 is a schematic diagram illustrating the flow of information within the data processing system according to the present invention with respect to electronic mail which has been sent by a client to a broker representative;

FIG. 32 is a schematic diagram illustrating the flow of information within the data processing system according to the present invention with respect to electronic mail which has been sent from a broker representative to a client;

FIG. 33 illustrates a user interface display or screen showing the inbox of the e-mail function of the broker representative's version which allows the broker representative to receive e-mail, reply to the author of the received e-mail, or forward any e-mail message. This screen also shows pertinent information for not only e-mail received from a client, but also e-mail which has been approved/disapproved by a branch manager and sent back to the broker for review;

FIGS. 34-36 illustrate various pull down menu options displayed on the user interface screen or display corresponding to the inbox tab of the e-mail portion of the representative's version.

FIG. 37 illustrate a user interface screen or display corresponding to the main menu inbox tab of the e-mail portion of the representative's version;

FIG. 38 illustrates a user interface display or screen showing the branch outbox tab of the e-mail portion of the representative's version;

FIG. 39 and FIG. 40 illustrate various pull down menu options to the outbox tab of the e-mail portion of the representative's version;

FIG. 41 illustrates a user interface screen or display of the sent items tab of the email portion of the representative's version;

FIGS. 42 and 43 illustrate the various pull down menu options corresponding to the sent items tab of the e-mail portion of the representative's version;

FIG. 44 shows a user interface screen or display of the new message tab of the email portion of the representative's version;

FIGS. 45-47 illustrate various pull down menu options corresponding to the new message tab of the e-mail portion of the representative's version;

FIG. 48 illustrates a user interface screen or display for a print command of the email portion of the representative's version;

FIG. 49 illustrates a user interface screen or display for an address book of the email portion of the representative's version;

FIG. 50 is a user interface screen or display showing the check incoming messages tab of the e-mail portion of the branch manager's version;

FIGS. 51-53 illustrate various pull down menu options corresponding to the check incoming message tab of the e-mail portion of the branch manager's version;

FIG. 54 illustrates a user interface screen or display showing the searched words function which allows e-mail message text to be scanned for usage of any words as identified by the user;

FIG. 55 is a user interface screen or display showing the check outgoing messages tab of the e-mail portion of the branch manager's version; and

FIGS. 56-58 illustrate various pull down menu options corresponding to the check outgoing messages tab of the e-mail portion of the branch manager's version.

FIG. 59 is a user interface screen or display showing the new messages tab of the e-mail portion of the branch manager's version.

FIG. 60 is a schematic diagram illustrating the major components of a second embodiment of the data processing system, and the flow of information within the data processing system according to the present invention;

FIG. 61 illustrates a user interface screen or display of the manner in which a user logs onto the website;

FIG. 62 illustrates the start screen or display which a user may access to navigate the website, in order to select execution of certain functions;

FIG. 63 is another user interface screen or display illustrating an example of a browse transaction option enabling the user to browse selected data in the data processing system;

FIG. 64 is another user interface screen or display illustrating an example of a browse client profile screen enabling the user to browse selected client data in the data processing system;

FIG. 65 is a user interface screen or display showing the manner in which a user may request output of a report, such as a daily trade blotter; and

FIG. 66 is a user interface screen or display which may be utilized by an administrator to add system users, change passwords, or conduct other administrator functions with regard to authorized users in the data processing system.

### V. DETAILED DESCRIPTION OF THE DRAWINGS

A. First Embodiment

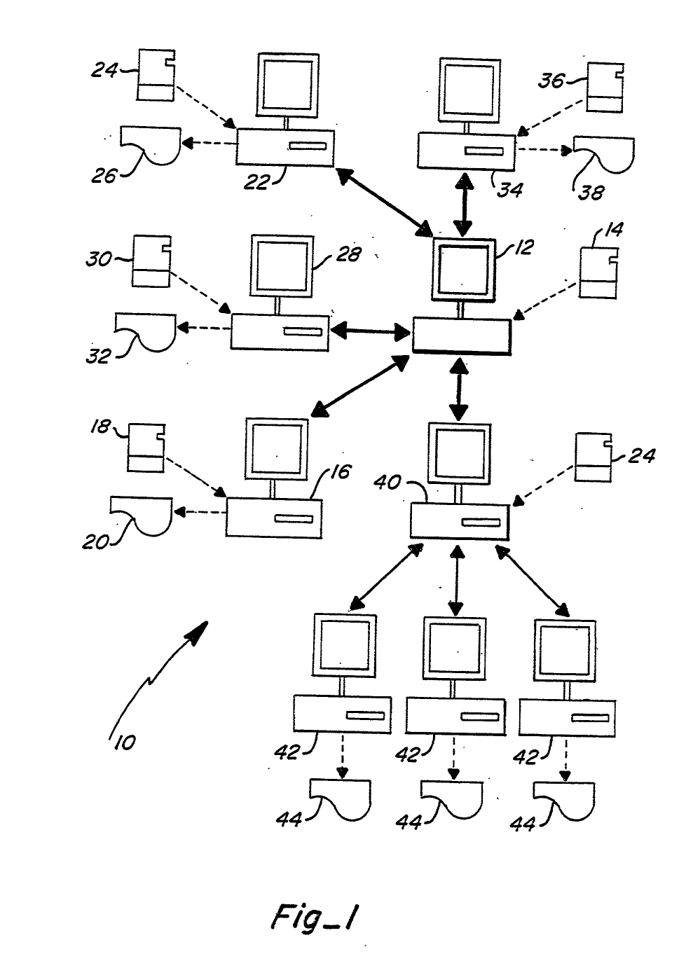

The data processing system 10 of the first embodiment of this invention is depicted as part of the schematic diagram of FIG. 1. First, there is a main server computer 12 which could be in the form of a sufficiently powerful personal computer having a central processing unit, main memory, and disk storage, as well understood in the art. The computer 12, as well as the others to be discussed below, can be sufficiently powerful personal computers which have the capability to store and to implement data processing instructions from computer software loaded thereon. The computer 12 is also equipped with a modem and other necessary hardware which allows it to communicate with other computers via the worldwide web. The modem, necessary hardware, and the encryption/decryption software discussed below can be generally referred to as communication means in the invention. The main server computer 12 hosts the main server database and TCP Listener software 14, which may be stored on a computer disk, CD ROM, or other storage media well known in the art. The TCP Listener is the set of program instructions or software which resides with the main server database, and is responsible for facilitating the transfer of data to and from each local database installation (i.e., the various installations of the broker representative's, branch manager's, and regional compliance director's versions), once a proper data transfer request has been made by an authorized user, and then updates the main database with the new data received from the remote locations. As discussed, all data transferred in the data processing system is by secure means through data encryption/decryption. For each installation of the data processing system, there is only one main server database and one TCP Listener. There can be one, or a plurality of broker representative's versions/branch manager's versions/regional compliance director's versions of software established within the data processing system. A DBMS administrator computer 16 communicates with the main server computer. The DBMS administrator's computer 16 hosts the DBMS administrator's software 18 which also maybe stored on a CD ROM or other storage media known in the art. As with the main server computer 12, the DBMS Administrative computer 16 may be a personal computer, including its own central processing unit, main memory, and disk storage. The DBMS Administrator computer 16 has the option of utilizing a peripheral such as a printer 20 which may produce desired printed outputs. One or more single user broker representative's computers 22 communicate with the main server database computer 12 to input various client, broker representative, and trade information as further discussed below. The broker representative's computers 22 may have the same capabilities as computers 12 and 16. The broker representatives' version of software 24 is loaded on the respective broker representative computers 22. Each broker representative's computer 22 has the option of including a peripheral such as a printer 26 in order to print desired output data. A branch manager's computer 28 is also provided which, too, may have the same capabilities as computers 12, 16 and 22. The branch manager's computer 28 also exchanges data with the main server computer 12. The branch manager's computer 28 has the branch manager's version of software 30 loaded thereon which allows the branch manager to interface with the data processing system. The branch manager's version of software 30 is similar to the broker representative's version 24; however, the branch manager's version 30 does not allow for creation of new trade records or the modification of trade records which have been created and stored on the main server database 14. The branch manager's computer 28 may also utilize a peripheral such as a printer 32 to create desired printed outputs. A regional compliance director's computer 34 is provided which also may interface with the main server computer 12. The regional compliance director's computer 34 has the regional compliance director version of software 36 loaded thereon. The regional compliance director version of software 36 is also similar to the broker representative's software 24, but, like the branch manager's version, also does not allow for the creation or modification of trade records. The regional compliance director's computer 34 may also include a peripheral such as printer 38 in order for outputs to be reproduced in hard copy.

In lieu of or in addition to a plurality of single user broker representative computers 22, one computer may be designated as a multiple user LAN computer 40 which facilitates data exchange between the main server computer 12, and a plurality of LAN broker representative computers 42. Multiple-user LAN computer 40 has the broker representative's version of software 24 loaded thereon. Each of the broker representative's computers 42 has a modified version of the broker representative's version loaded thereon wherein the modified version has all the functionality of the regular representative's version, but each computer 42 shares the single database located at computer 40. Each of the computers 42 within the LAN may also include their own corresponding printers 44 for printing desired outputs.

When the data processing system includes a LAN wherein one installation of software 24 is shared by a number of individual computers 42, each user will still be assigned their own user ID and password. All of the broker representative users in the LAN system enter data in the same manner as would a broker representative in a stand-alone single installation. Such LAN users also can view all trade records entered in the common local database of computer 40.

The computers 40 and 42 may also be personal computers having their own central processing unit, main memory and disk storage capability like the other computers mentioned above. In all the computers mentioned above, each are equipped with their own video monitor or other means to visually observe the entry, exchange, processing and output of data within the data processing system.

The main server computer 12 may incorporate a commercially available database for use as the main server database which has the capability to store and otherwise manipulate data according to the various software means used in the invention. Databases which may be used include Oracle™ or SQL Server™ type databases.

FIG. 1 illustrates the use of two separate computers, 12 and 16, for execution of instructions from the software 14 and 18. However, it shall be understood that one computer of sufficient power and speed could be used to host both pieces of software. Thus, computers 12 and 16 could be just one computer. The software incorporated within the data processing system of this invention includes separate diskettes or CD ROMs for the various user versions (broker representative's version, branch manager's version, and the regional compliance director's version). The main server database and TCP Listener software 14 are also typically stored on a separate diskette or CD ROM. The DBMS Administrator software 18 may be incorporated with the broker representative's version as a separately identified module, or may be stored separately on its own diskette or CD. Alternatively, as well understood in the art, each of the different groups of software could be downloaded from the worldwide web.

Any data which is exchanged between computers is achieved through secure means. Accordingly, all data sent from a particular computer is encrypted, and the data is then decrypted at the receiving end. As known to those skilled in the art, conventional key distribution protocols may be used to provide the encryption/decryption capability to the data processing system. For example, data encryption/decryption may be achieved with a 56 bit DES-type algorithm.

Prior to processing broker trade information, various data files must be set up in the main server database, along with identification and authentication of each user in the system.

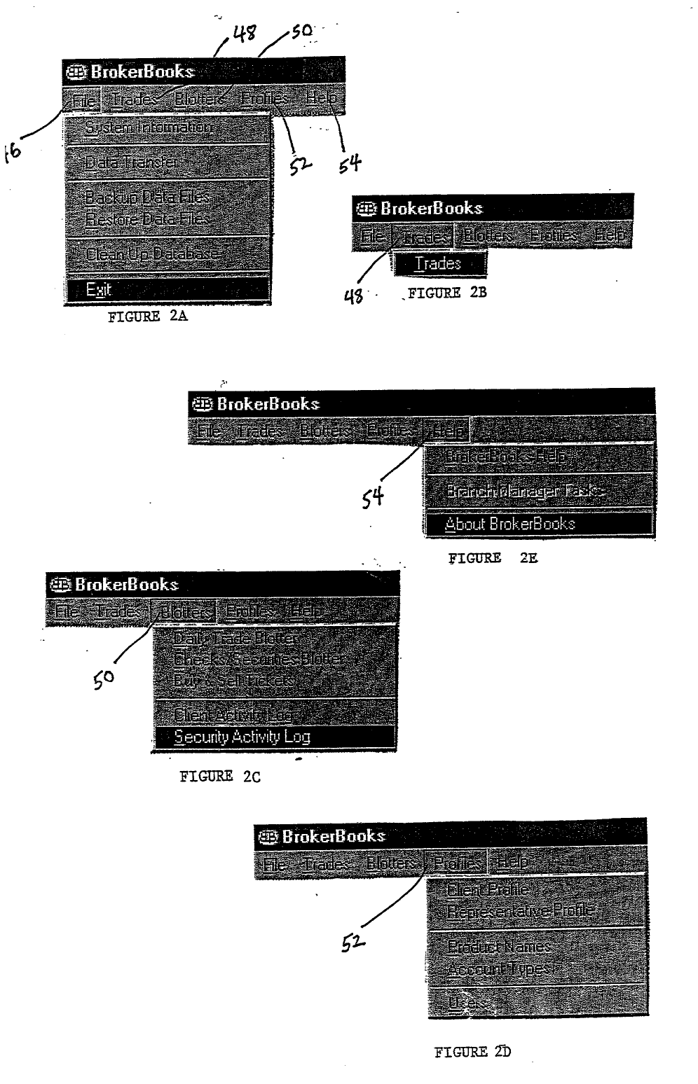

FIG. 2A illustrates a main menu which may be used to help a user navigate the data processing system of the invention. The broker representative's version of software 24, the branch manager's version of software 30, and the regional compliance director's version of 36 could all be organized in the manner shown in FIGS. 2A-2E. The main menu options, as shown, may include File 46, Trades 48, Blotters 50, Profiles 52, and Help 54. File option 46 has a number of sub-options in the form of a pull down menu, shown as system information, data transfer, backup data files, restore data files, clean up database, and exit. The Trades option 48, as further discussed below, allows the entry and storage of trade data, manipulation of trade data, and the approval of trades. The Blotters option 50 allows one to choose various system outputs to include a daily trade blotter, a check/securities blotter, buy and sell tickets, a client activity log, and a security activity log. The Profiles option 52 allows a user to set up or update various data to include client profiles, broker representative profiles, product names, account types, and users. The Help option 54 provides specific information about the use of the system and also serves as a troubleshooting tool.

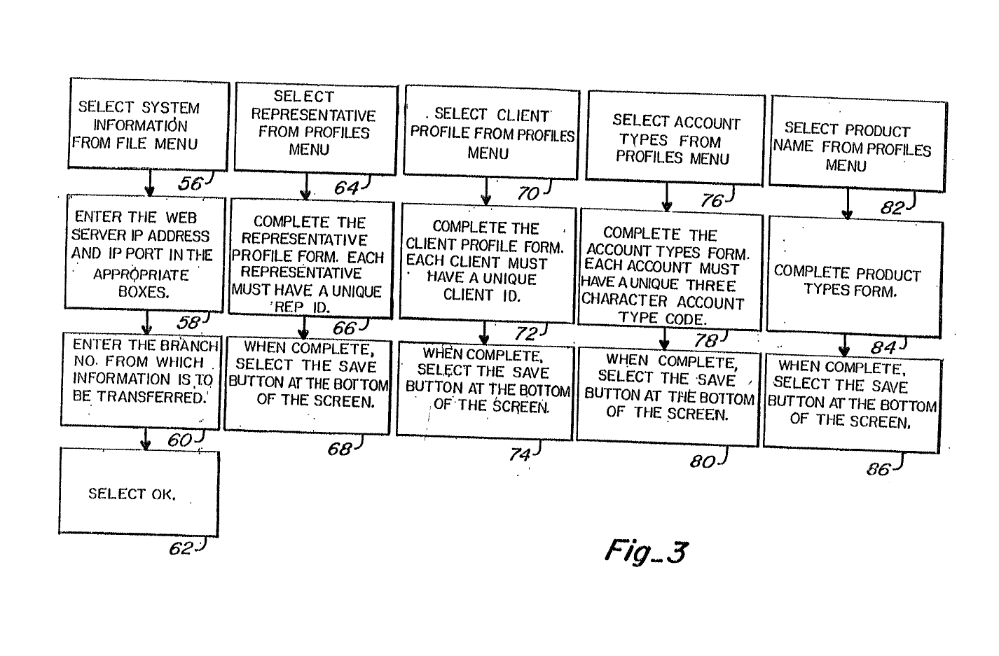

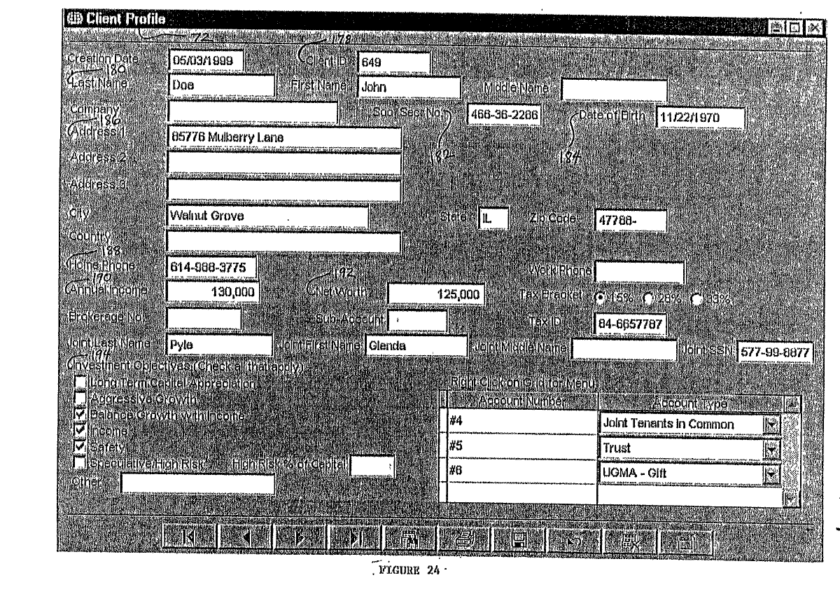

FIG. 3 includes a series of flow diagrams illustrating the set-up process for initiating the data processing system to accept and process data. As shown, the first step in the set-up process would be to select the system information sub-option within the corresponding pull down menu, shown at block 56. A user would then enter the web server IP address and IP port in the appropriate dialog boxes in order to identify the location at which data is to be transferred, shown at block 58. The web server IP address and IP port correspond to the location and identity of the main server computer 12. The computer from which information is to be transferred must then be identified, shown at block 60. Each brokerage company or entity which uses the data processing system is assigned its own branch number. Once the above information has been entered, it is confirmed, as shown at block 62. The next step in the set-up process is to select the broker representative profile sub-option within the pull down menu option of the Profiles, shown at Block 64. Next, a user would enter information regarding a particular broker representative by completing a profile form. Each broker representative is assigned a unique broker representative ID number from the system administrator, as shown at block 66. After completion of the data entry, the user would select a “save” option to enter the data, shown at Block 68. Next, a profile is created for each client. As shown, a user would select the client profile sub-option from the pull down menu of the Profiles menu option, as shown at block 70. Next, data would be entered regarding each client, and each client would also be assigned its own unique client identification number, shown at block 72. Once completed, the client information profile is confirmed and this information is stored in the system, as shown at block 74. Optionally, the set-up process may also include data entry for account types and products. If it were desired to enter this type of data in the data processing system, it is preferable first to set up these data entries. The process for establishing entry of this data is the same as with the other information. For example, a user may select account types from the pull down menu of the Profiles menu option, shown in block 76, enter the account type which may be assigned a unique three-character account type code, shown at block 78, and then confirm entry of the account information at block 80. Similarly, product information could be entered by selecting the product name sub-option from the pull down menu of the Profiles menu option, shown at block 82, entering the product type information, shown at block 84, and confirming entry of the product type data, as shown at block 86. FIGS. 24 and 25 discussed below detail the type of information found in the profile screens.

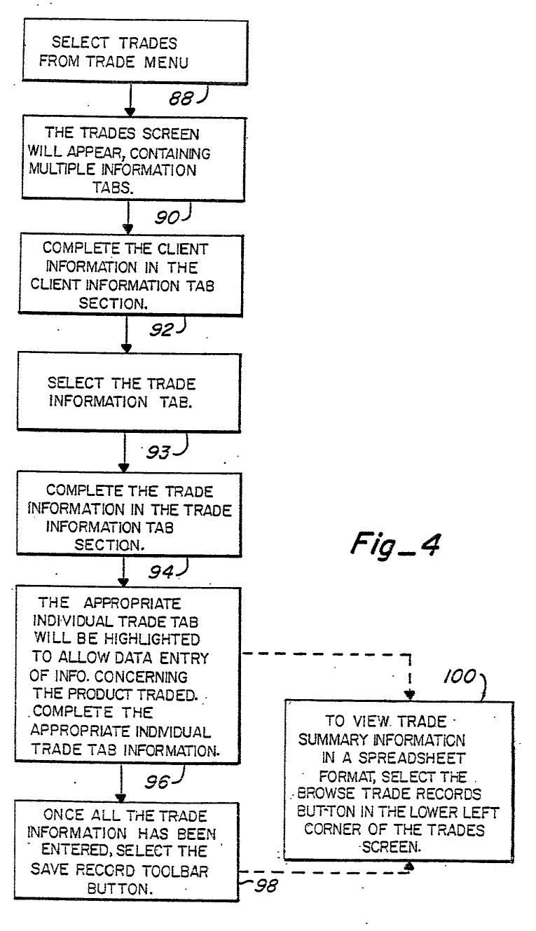

After the profile information has been entered, trade data may be entered and recorded. As shown in FIG. 4, a broker representative would select the trades sub-option in the Trade menu, as shown at block 88. A user interface screen is provided containing multiple informational tabs which allow a broker representative to enter information regarding a trade, as shown at block 90. The broker representative then enters information concerning the type of trade and the particular client, as shown at blocks 92-94. Depending upon the type of trade, additional information may be entered regarding the particular type of product traded, such as stocks and bonds, mutual funds, options, etc., as indicated at block 96. Once all the trade information has been recorded for a particular trade, the user prompts the information to be recorded on the representative's computer, as shown at block 98. Optionally, if the broker representative wishes to review a summary of all the trade information in a spread sheet format, the broker representative may select a browse trade records button, as further discussed below, and shown at Block 100. The foregoing description of data entry shows that a wide array of information can be entered into the data processing system concerning not only trades, but information regarding the particular client and the broker representative.

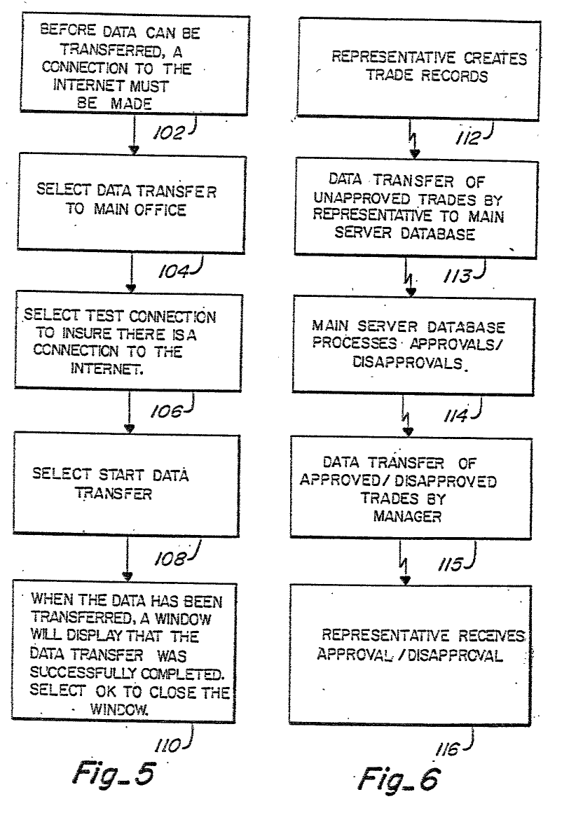

The next step in the data processing system is to have the information which has been entered in the local database of the representative's computer transferred to the main database. As shown in FIG. 5, before data can be transferred, a connection to the Internet must be made to allow communication between the particular broker representative computer 22/42, and the main server computer 12. When an Internet connection is made, as shown at block 102, the broker representative then selects the option to transfer data to the main server, indicated at block 104. A test connection may be selected to ensure that there is a connection available to the Internet, shown at block 106. The user then selects a start data transfer option shown at block 108. The system will indicate that the data transfer was successfully completed, shown at block 110. Thus, the data transfer by a broker representative in the form of profile information and/or an unapproved trade(s) to the main server computer 12 is complete. Typically, a user having administrator level privileges would be the one who would actually execute the transfer data function as discussed further below with regard to FIG. 16. Executing the data transfer function would handle the transfer of all trade records which needed to be recorded in the main database, and also any trade record information which needed to be sent back to the broker representative based upon approval/disapproval from the branch manager.

Once trade data has been received and recorded at the main server database, it is the responsibility of the various branch managers to approve the particular trade(s). The responsible branch manager through computer 28 makes a connection to the Internet and requests a data transfer in order to receive information from the main server computer 12 indicating which trades need to be approved. Then the branch manager will signify approval or disapproval of the requested trade by, for example, entering a character in a dialog box on the user interface screen which displays information on the requested trade. This approval/disapproval is sent back to the main server computer 12 by the branch manager again requesting a data transfer. The approval/disapproval is then forwarded to the inquiring broker representative once the broker representative requests a data transfer. The branch manager's version of software 30 has the functionality to review all trade-related data entered into the system, such as trade information, client information, and broker representative information. However, the branch manager's version of software 30 does not allow for any changes or modifications to the actual trade records. Accordingly, the primary interaction between the branch manager and the data processing system is review of trade records, and approval or disapproval of trade requests.

The regional compliance director software 36 allows a regional compliance director to access data files to check for compliance in accordance with SEC rules. However, the regional compliance director software 36 does not allow for changes or modification to any trade records, nor does it allow a regional compliance director to approve or disapprove of any trades. Accordingly, the regional compliance director software 36 allows the regional compliance computer 34 only to communicate with the main server computer 12 to review trade, client, and broker representative information. As with the branch manager's and broker representative's computers, the regional compliance director's computer communicates with the main server computer 12 as by an Internet connection wherein data files are transferred electronically in a secure environment once the regional compliance director executes a data transfer request.

FIG. 6 summarizes the flow of data to and from a broker representative. As shown, a representative creates trade records, shown at block 112. The broker representative transfers data reflective of unapproved trades to the main server database, as shown at block 113. The main server database receives the unapproved trades, and processes the unprocessed trades by interaction with input from the branch manager(s), as shown at block 114. Approved/disapproved trades are transferred back to the representative, as shown at block 115, and finally the representative receives the approved/disapproved trade, and takes the appropriate action, as shown at block 116.

As with the representative's version, the branch manager's version also allows data transfer to and from the main server database. Prior to data transfer within the branch manager's version, the same procedure as set forth above with respect to FIG. 5 must take place. That is, a connection to the Internet must be made, the branch manager selects data transfer to/from the main server database, a select start data transfer button is activated, and after the data has been transferred, a window will display that the data transfer was successfully completed.

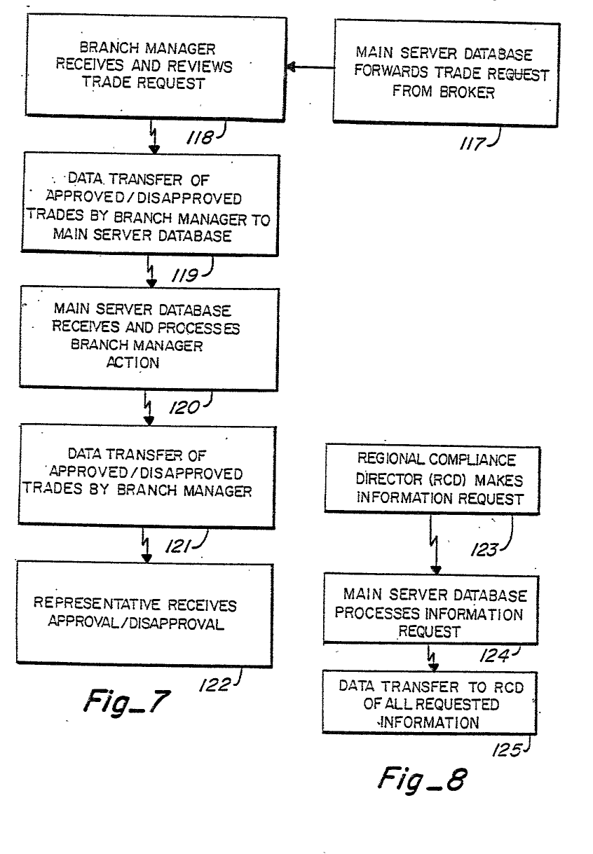

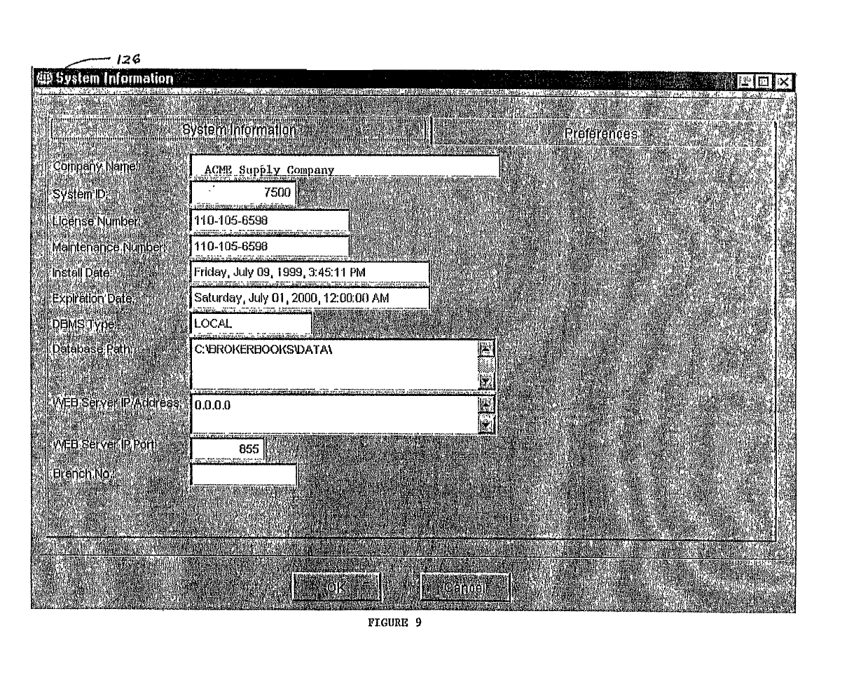

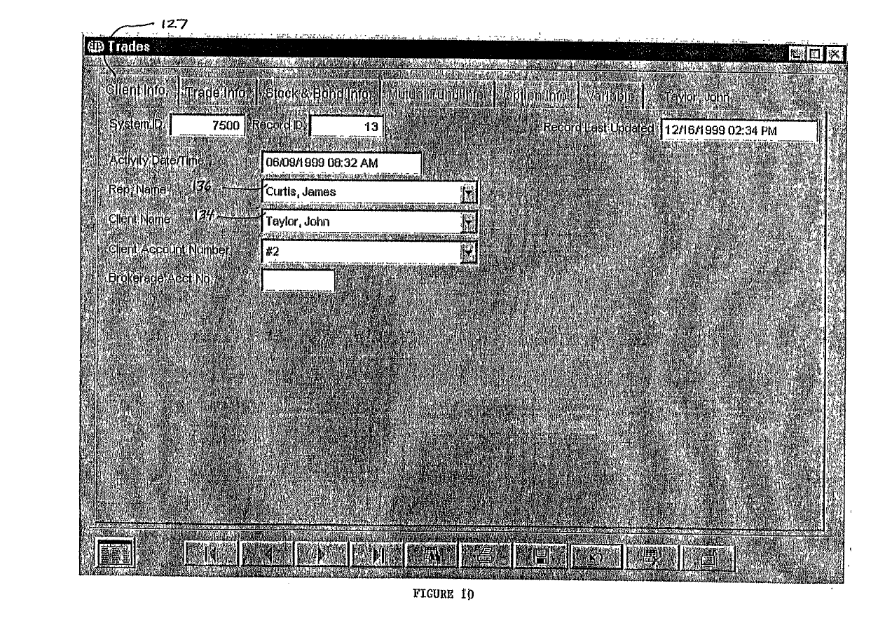

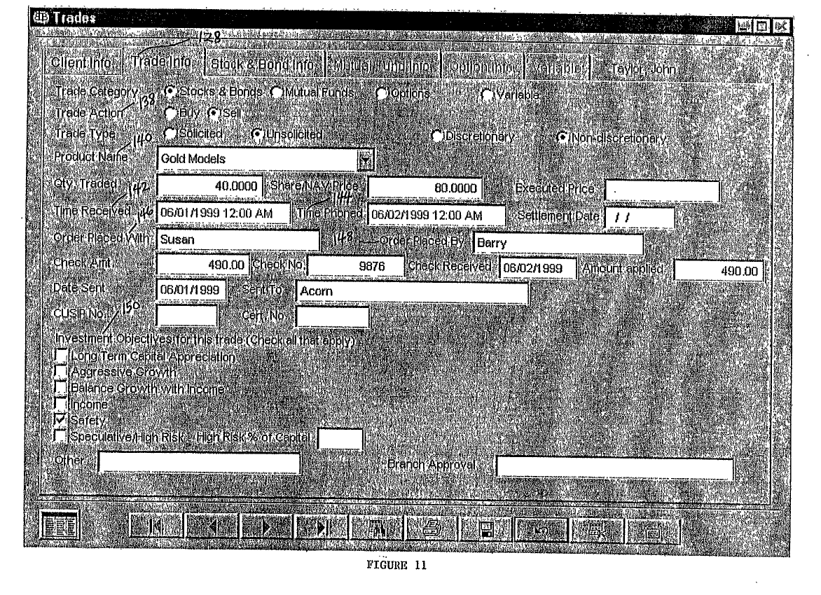

FIG. 7 summarizes the flow of data to and from a branch manager. As shown at block 117, the main server database forwards a trade request from a broker after the branch manager requests the data transfer. The branch manager receives and reviews the trade request, as shown at block 118. The branch manager's decision in the form of an approval/disapproval is transferred back to the main server database, as shown at block 119. The main server database receives and processes the approved/disapproved trade, as shown at block 120. The approved/unapproved trade is then transferred back to the branch representative, as shown at block 121, when the broker representative requests a data transfer the next time the representative accesses the data processing system. The broker representative receives and reviews the approved/disapproved trade, as shown in block 122.

FIG. 8 summarizes the flow of information to and from a regional compliance director. As shown, a regional compliance director requests information about a particular client, broker representative, or trade, as shown at block 123. The main server database processes the information requested, shown at block 124. Data is then transferred to the regional compliance director corresponding to the requested information, as shown at block 125. The regional compliance director's version of software allows a regional compliance director to review information for the various branches which are within the data processing system. However, the branch manager's version and the broker representative's version are set up so t hat these personnel can only deal with information which concerns their particular branch. Thus, the TCP Listener discriminates between the various branches in terms of communication by the various branch managers and broker representatives, and allow regional compliance directors to review information from specific branches within the data processing system. Like the representative's and branch manager's versions, the compliance director's version also requires that the particular regional compliance director select a data transfer function when requesting information. Thus, the discussion set forth above with respect to FIG. 5 also applies to data transfer to and from the main server database to a regional compliance director.

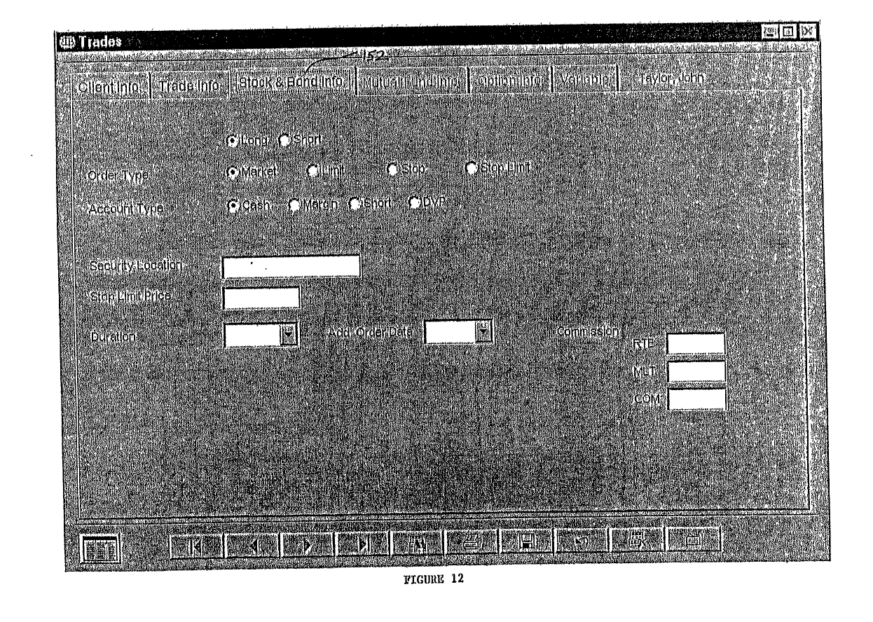

FIG. 9 illustrates a user interface display or screen 126 which a broker representative completes to enter system information. It should be understood that the particular information or data shown in this and the following figures is fictitious and is provided only for purposes of clarifying the type of information which may be entered and processed in the data processing system. It should also be understood that FIG. 9 and the following figures contain a number of dialog boxes for data entry corresponding to various data fields. Each of these dialog boxes may be modified as necessary to allow data entry of the desired data. Therefore, it is within the spirit and scope of this invention to modify as necessary the various dialog boxes as shown on the numerous user interfaces screens or displays in order to best effect the control and manipulation of broker data transactions.

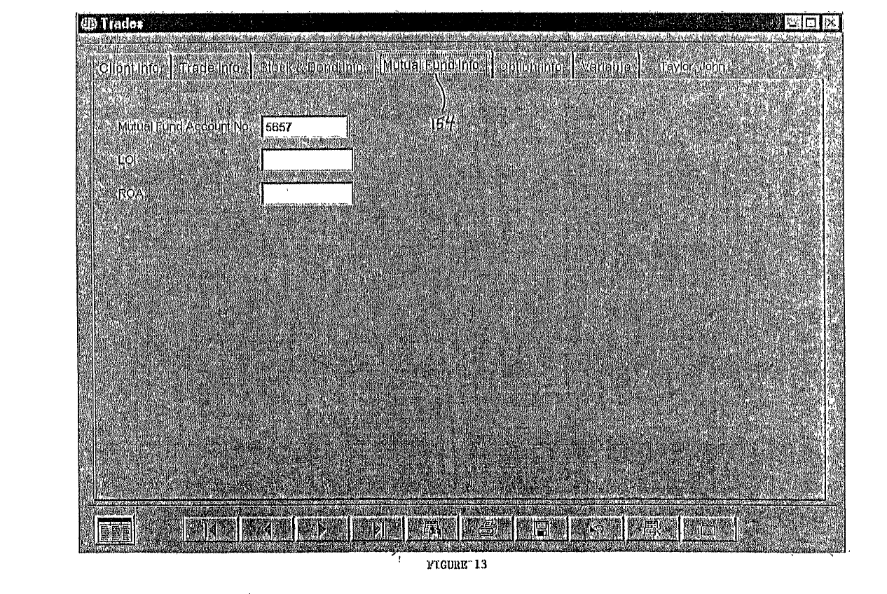

FIG. 10 shows a user interface screen 127 for entering the client information for a particular trade. As discussed above, a profile has been previously created for each client and broker representative through the Profiles menu. In order to create a trade record, there is minimum information which should be entered regarding the trade transaction. In the case of FIG. 10, minimum information which should be entered about a trade includes the client name shown at dialog box 134, and the broker representative who is making the trade shown at dialog box 136.

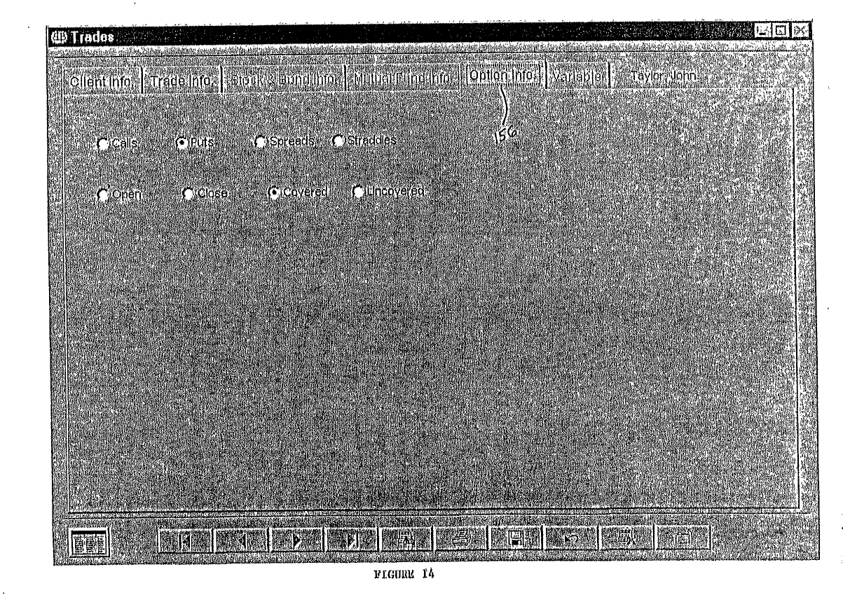

FIG. 11 illustrates the trade information tab 128 of a user interface display or screen wherein the broker representative enters the trade specific information to create a trade record. For this particular screen, the data fields which should be completed in the corresponding dialog boxes include the trade action 138, the product name which is to be traded 140, the time received 142, the time the order was phoned 144, the person to whom the order was placed 146, the person from whom the order was placed 148, and the particular investment objective for the trade 150.

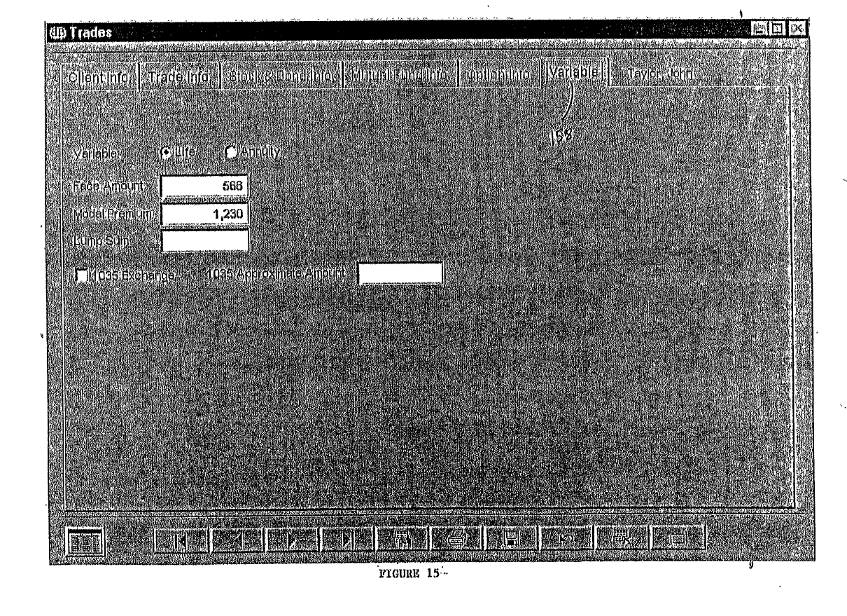

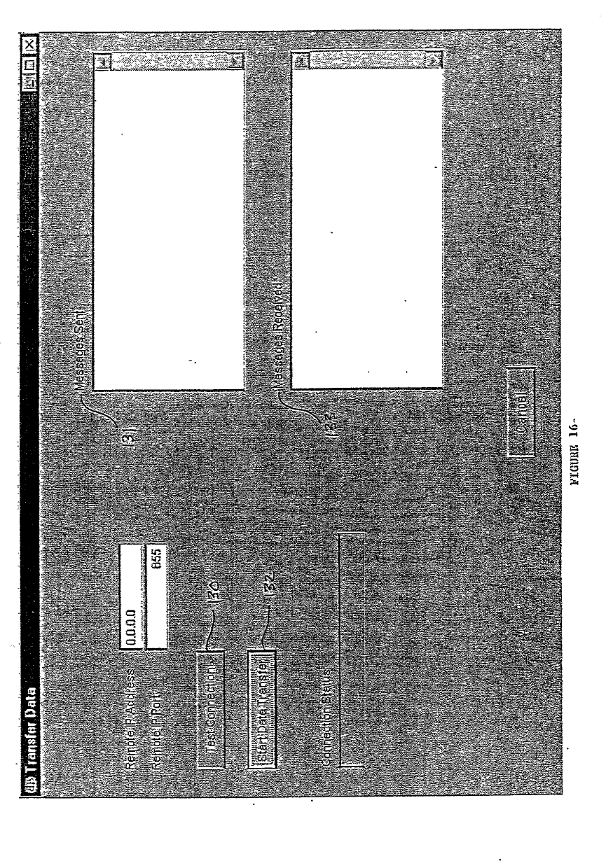

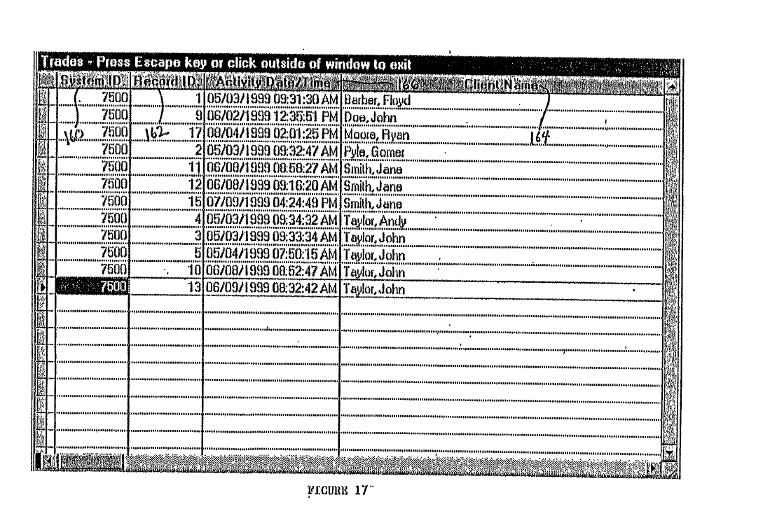

FIGS. 12-15 illustrate the product tabs which are completed to enter information regarding a particular type of product to be traded. As shown, FIG. 12 illustrates a user interface screen for stock and bond information 152, FIG. 13 illustrates a user interface screen for entry of mutual fund information 154, FIG. 14 illustrates a user interface screen for entry of option information 156, and FIG. 15 illustrates a user interface screen for entry of variable information 158.

FIG. 16 illustrates a transfer data screen or display which is used by a user to transfer data to the main server computer. As shown, a test connection button 130 is provided for testing an Internet connection, and a start data transfer button 132 is provided to prompt data transfer once a test connection has been confirmed. FIG. 16 illustrates a data transfer screen which is used in the broker representative's version. The same type of transfer data screen is also used in the branch manager's version and the regional compliance director's version in order to execute data transfer. The messages sent window 131 displays transaction data being sent to the main database, and the messages reviewed window 133 displays transactions downloaded from the main server to the various broker representative's computers, or the branch manager's/regional compliance director's computers if those users are involved in the data transfer request.

It should be understood that the transfer data screen of FIG. 16 represents a typical display which shows how data is transferred to and from the main server database from the various system IDs or local installations. Thus, it is imperative that the users activate the data transfer function at least daily. The data processing system of this invention can be set up such that any user can execute a data transfer function; however, it is preferable that the data transfer function be reserved for only those users who have administrator level privileges. For remote installations of the broker representative's version, it may be necessary for a particular broker to have administrative level privileges to effectuate timely data transfer. However, in certain circumstances wherein a LAN is used, one particular broker representative could be designated to be the system administrator in order to execute a data transfer. Depending upon the locations and the different office arrangements of a particular brokerage firm, selected branch managers and/or regional compliance directors may also be designated as system administrators in order to effectuate timely data transfer. In those circumstances wherein a particular broker acts as an independent broker and is not part of a larger brokerage house, that particular independent broker should be designated as the system administrator as no other party would normally have access to the broker's computer to effectuate data transfer.

As can be seen from the foregoing, an exhaustive and extremely detailed amount of information can be recorded about each trade, each client, and each broker representative who is handling a particular transaction. As understood by those skilled in the art, the foregoing data is kept in files or records in the main database, and can be sorted or otherwise arranged according to any predesignated fields desired.

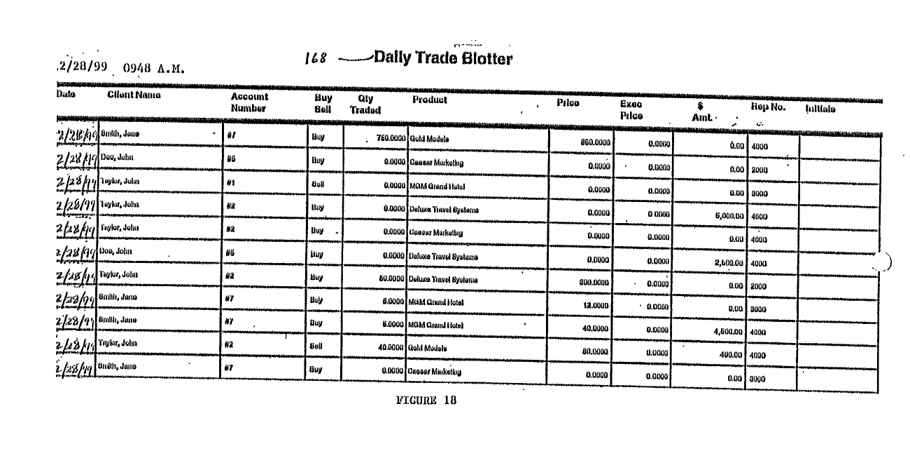

FIG. 17 shows one example of the type of data output which may be created. This output may be referred to as a browse records output which allows a broker representative, branch manager, or regional compliance director to find information regarding a particular client or trade, As shown in FIG. 17, this output may in the form of a user interface screen or display which shows various data fields. In this particular example, a user has chosen to view trade records of a particular system ID 160. The system identification refers to the particular installation of software corresponding to a unique and separate entity, such as a particular broker representative. FIG. 17 further shows a trade record identification number 162 corresponding to a specific trade or a particular client 164, and the date/time 166 in which the trade record was entered in to the system. As shown, each trade of each client has its own unique record ID number corresponding to a particular system ID which allows each and every trade record to be distinguished from any others.

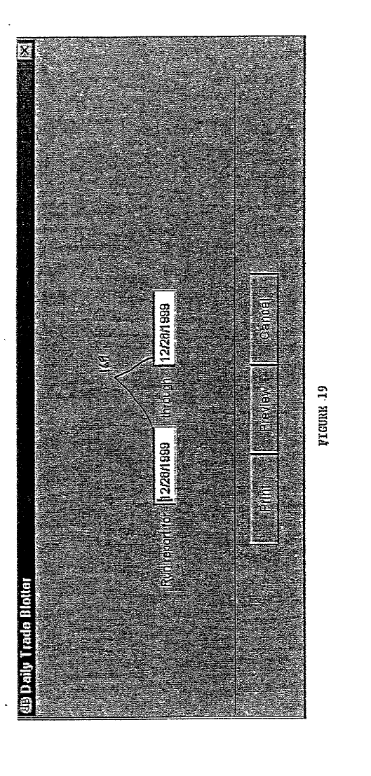

In accordance with SEC regulations, there are a number of recurring reports which a brokerage must maintain and be able to produce for an SEC inspector. One of these reports is known as a daily trade blotter, as shown in FIG. 18, which may be produced by the data processing system of this invention. The daily trade blotter 168 is a record of all trade activity which has occurred during a designated time frame within a specific branch. The data processing system is able to produce this output due to the sorting of data files according to time, or whatever data field parameters are chosen by the user.

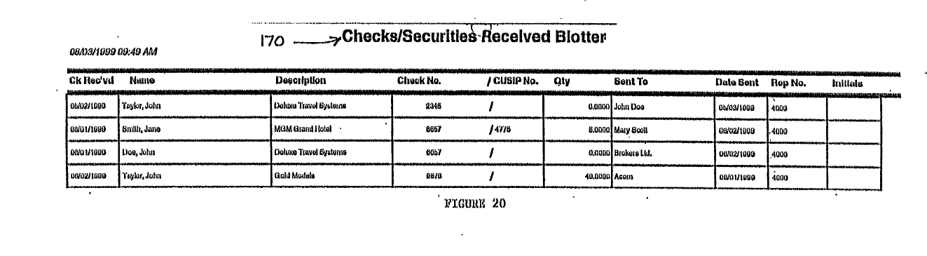

FIG. 19 illustrates the means by which a user may request a daily trade blotter for a specified period of time. As shown in the example of FIG. 19, a trade blotter has been requested only for trades occurring on Dec. 28, 1999, by entering the date in the corresponding dialog boxes 169.

FIG. 20 is another example of an output which may be created from the data processing system of this invention. As shown, this output is in the form of a checks/securities received blotter 170 which is also created to reflect activity of a particular branch. This is also an example of a report which is required to be kept according to SEC regulations.

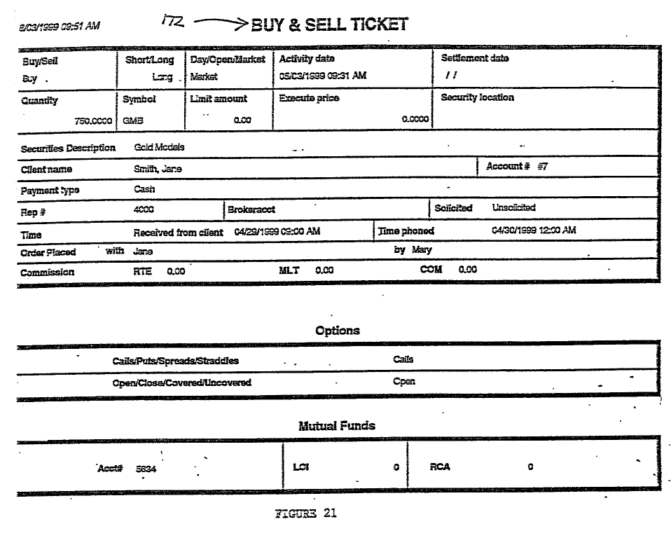

FIG. 21 is another example of an output which may be created from the data processing system of this invention. As shown here, a buy and sell ticket 172 may be produced for each trade record created. A buy and sell ticket is also information which is required to be maintained by SEC rules.

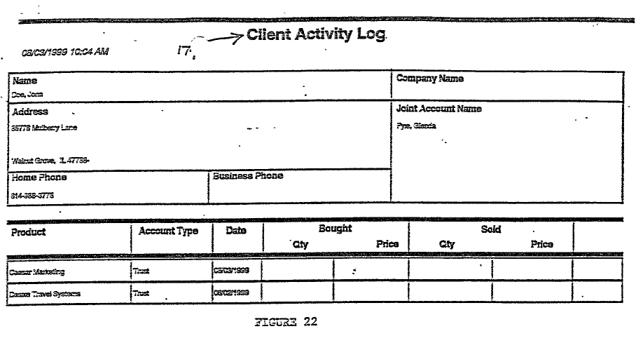

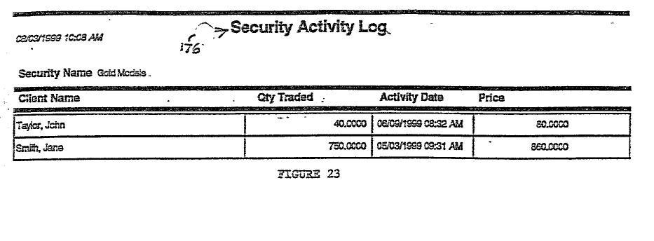

FIGS. 22 and 23 are yet other examples of reports or outputs which can be created by the data processing system of this invention. As shown, FIG. 22 is a client activity log 174 and FIG. 23 is a security activity log 176. As with the creation of the daily trade blotter of FIG. 18, the reports/outputs of FIGS. 20-23 may be prompted by a user who utilizes a data output request such as shown in FIG. 19. These reports or outputs may be run for specified time periods or may be sorted according to other data fields.

FIG. 24 illustrates a user interface screen or display which may be used by a user for entry of information regarding a particular client, in the form of the client profile 72. The fields which should be entered in order to create a client profile include the client ID number 178, the client's name 180, Social Security No. 182, date of birth 184, address 186, home telephone 188, annual income 190, net worth 192, and investment objectives 194. As shown, there are also other data fields which may be used for additional data entry concerning a particular client.

FIG. 25 illustrates the user interface screen or display which is used by a user for creating a broker representative profile 66. The data fields which should be completed in the broker representative profile 66 include the broker representative ID number 196, name 198, address 200, telephone 202, branch 204, and license information 206. The license information relates to the licenses which are held by the particular broker representative which indicate the type of securities which the broker representative may legally trade.

As can be appreciated by a review of the reports shown in FIGS. 18 and 20-23, the data or information found therein has all previously been entered into the data processing system through creation of particular trade records, and the completion of the client and representative profiles.

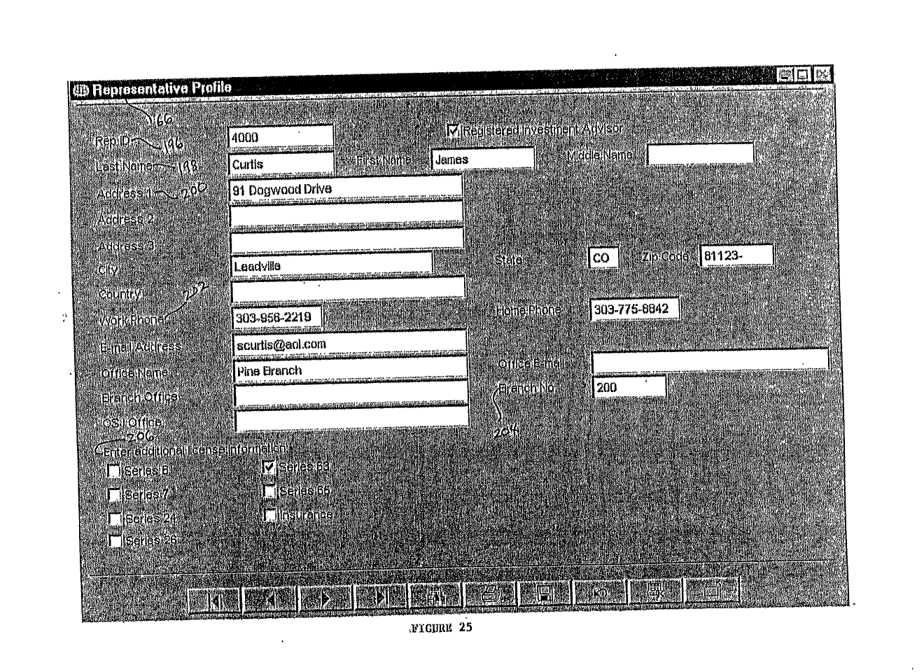

One of the important aspects of the data processing system of this invention is the security features which prevent unauthorized system access and prevent unauthorized tampering of trade records. One of the reasons the SEC requires such extensive record keeping for brokers is to prevent fraud or other illegal activity with regard to the trade of securities. Through the data processing system of this invention, the tampering of trade records is made quite difficult which better achieves the regulatory objectives of the SEC and, of course, better serves all clients. As shown at FIG. 26, the users sub-option 208 of the profiles menu option 52 provides a user interface screen or display which sets up user information and authorizations. As shown, there are a number of fields which can be entered, including the user ID 210, the user name 212, the user level 214, and the password 216. Each user in the system must be identified by user ID, name, user level and password. For each installation of the software in the data processing system, one user must be designated as the administrator. This person is responsible for setting up access to the system by the other users and for transferring data from the local databases (i.e., the distinct software installations at the broker representative, branch manager and regional compliance director locations). Accordingly, the administrator administers the authentication of unique user IDs and passwords. A person granted administrator level privileges is able to access all user screens and to edit or add trade records, or change other data such as client or broker profiles. The next level of user authority or access is simply the user level. Users at the user level of authorization include broker representatives, branch managers, and regional compliance directors. As discussed above, each of them are assigned a particular user ID from the administrator. Each of the users selects their own password or are provided a password from the administrator. In order for a user to gain access to the data processing system, the user must enter his/her user ID, password, and system identification number. The system identification number corresponds to the particular installation of a software version at a remote site. The system administrator is also responsible for identifying and setting up the specific user(s) with each system ID. As discussed above, different versions of the software of the data processing system provide different functions. For example, the branch manager's version and the regional compliance director's versions 36 do not allow for entering or altering trade record information. Even if a branch manager or regional compliance director were to access a computer containing the broker representative's version, the data processing system would not allow such persons to enter or alter trade record data. The data processing system recognizes users by user ID and passwords, and only allows a user to conduct activities in the system commensurate with their authorizations. It is possible to install the broker representative's version of software 24 at each remote location to include the locations of the branch managers and regional compliance directors because the security features of the data processing system only allow users to operate within their specified authorizations. However, as a practical matter, the broker representative's version has greater functionality and is, therefore, a larger program which requires more computer memory, etc. Thus, installation of only those functional modules which are required at the different remote locations is a logical way to organize system installation.

The last user level which may be designated is the inactive user level. This inactive user level may be designated for any number of reasons, for example, a broker representative who has recently quit the particular brokerage house and has moved to another job must be differentiated from a representative still employed. Another situation in which the inactive user level could be activated is when there is suspicion of improper trade activity being conducted by a particular broker representative. In either case, the administrator may designate any user to be placed in the inactive status which prevents that particular user from any system access. Each time any user, to include an administrator, attempts to log on the system, an authentication takes place wherein the unique user ID, user level and password, as well as matching the system ID number, are verified by the DBMS Administrator software. A user who attempts to log on without correct identification will be denied access. As well understood by those skilled in the art, various error messages can be displayed at the particular user screen or display which indicate that access is denied for failure to enter the correct authentication data.

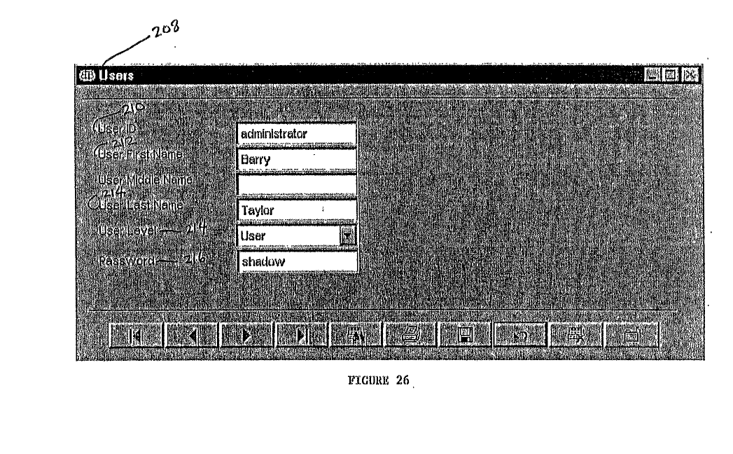

FIG. 27 illustrates a user interface screen or display showing a information which is a complete audit trail of modifications made to an example trade record once the trade record has been initially created by the representative and stored in the main database. This audit trail may be in the form of a audit report 210 which lists all activity with regard to the particular trade record. As shown, this audit report 210 identifies the particular trade record, all modifications made to the trade record by identification of the person or persons modifying the trade record, and the date and time on which the trade record was modified. As mentioned above, each and every modification made to a trade record is stored in the main database, to include changes made by a user having administrator level privileges. This type of complete audit trail provides security regulators the opportunity to see the “life history” of a trade record, and further prevents any unauthorized tampering of trade records. Of course, at some point in time, trade records no longer need to be kept in accordance with SEC guidelines. Accordingly, the administrator may, at the appropriate time, delete an entire trade record history, but does not have the capability to delete selected data fields showing modifications to a particular trade record. In this way, tampering is also prevented with regard to “active” trade records being maintained by the data processing system because the entire life history is preserved until such point in time when the trade record no longer must be maintained. Because deletion of trade records can only be accomplished by an administrator in accordance with the authorizations provided by the data processing system, this prevents a larger group of other users from having the ability to destroy trade records.

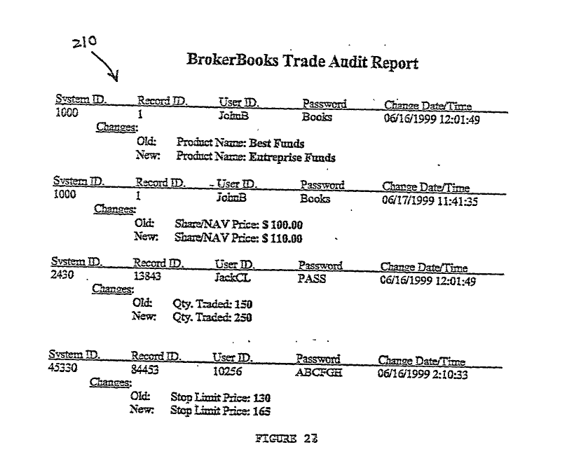

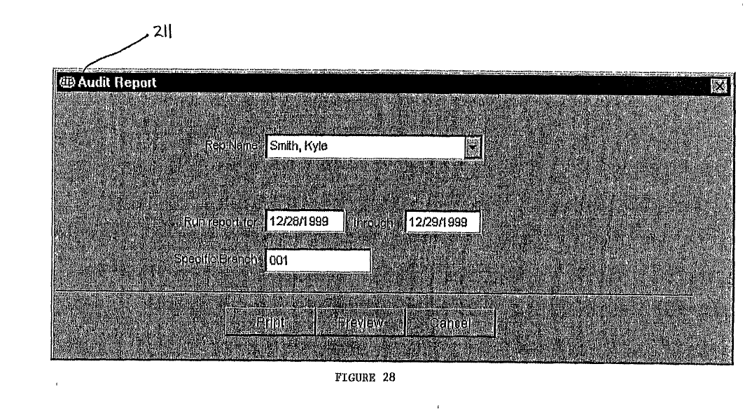

FIG. 28 illustrates a user interface screen 211 showing the means by which a user can select the output of data in the trade audit trail report based upon a selected representative, branch, and time period. The trade audit report can be requested via a menu option on the main menu, or can be accessed by a sub-menu option as desired.

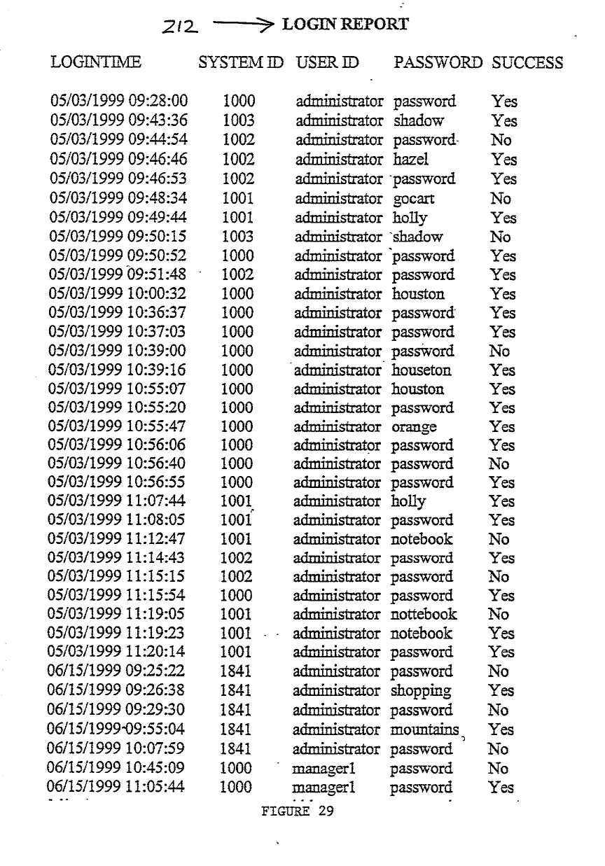

FIG. 29 illustrates yet another security feature of the data processing system which shows a log-in report for all those persons who have attempted to or who have actually logged on to the system. As shown, the log-in report 212 may be sorted according to date order. Also, this log-in report may be sorted according to a particular user. By viewing this log-in report, the frequency and type of activity that has occurred for each log-in can be observed. Additionally, if a number of failed log-in attempts are recorded based upon incorrect passwords, user IDs, or system IDs, this could indicate that an individual is attempting to breakthrough the security features of the data processing system. In any event, the log-in report also has use for maintaining compliance with SEC regulations as the log-in report can be used to verify specific trade activity, a specific user's activity, and critical dates and times.

FIG. 30 illustrates a user interface screen 213 by which a user can select the output of data in the log-ins report 212. The user interface screen 213 of FIG. 30 is very similar in format to the user interface screen 211 of FIG. 28, wherein the log-ins report can be run based upon a particular user, branch, and time period.

As a review of the data transfer within the data processing system, a broker representative enters trade data into his/her local databases. Each trade is identified by the system ID (particular software installation) of a particular branch office, and is also identified by the user ID of the broker representative who make the data entry. On a daily basis or as frequently as necessary, the user having administrator level privileges will connect with the main server database, via a standard Internet connection with the TCP Listener. All newly created , unapproved trade records and supporting data are copied to the main server database. Each branch manager responsible for approving trade records will have a separate installation of the branch manager's version. When the branch manager connects to the main server database and reports unapproved trades, the TCP Listener locates unapproved trades records and supporting data that have matching system Ids and branch numbers and transfers these trade records to the branch manager's local database. The branch manager uses hi/her version of the software to review and approve/disapprove the trades, and then reconnects to the main server to request transfer of the acted on trades. The TCP Listener identifies the newly approved trade records and copies them back to the main server. Finally, the newly approved trade records are returned to the original broker representative local database which created the trade record the next time the broker representative reconnects to the TCP Listener and request a data transfer.

The main server computer 12 recognizes each of the many local databases that connect to it by their unique system ID. Therefore, each local installation as discussed above must be assigned a unique system ID within each branch that has been pre-established by the system administrator and previously entered into the main server database. Without this identifying link, the main server database cannot track the trade records and other data properly.

As long as each local installation with the unique system ID and each broker representative and branch manager enter the correct branch number, the TCP Listener will be able to match and facilitate transfer of the data properly between the broker representatives and their branch managers).

The foregoing discussion of the broker representative's screens has illustrated the manner in which data can be entered, manipulated and outputted in the data processing system of this invention. The foregoing discussion has also presented the trade audit report which monitors the modification of any trade records which have been entered into the system. In order for a broker representative to modify a particular trade record, the broker representative's version includes menu options which allow the broker representative to find a particular trade by means of either the assigned trade record number, the client, or the data on which the trade record was created. Then, the broker representative can choose an edit option (not shown) which allows the broker representative to change a trade record as desired. As discussed above, any and all changes made to an entered trade record will be reflected in the trade audit report. In the branch manager's version, the branch manager is able to find a particular trade, or track the activity of a particular broker representative, by entering the trades option and locating a particular trade according to another menu option (not shown) which directs the branch manager to the trade desired. Alternatively, the branch manager may view the browse records report as shown in FIG. 17 and highlight/mark a particular trade for observation of the information in the trade record thereof Similarly, the compliance director's version provides functionality so a compliance director may find a particular trade or observe the activity of a particular branch or broker representative by conducting a search of a particular trade record or broker representative through the various menu options provided within the compliance director's version. In short, the branch manager's version and the compliance director's version provide screens very similar to the broker representative's version which would otherwise allow the branch manager or compliance director to modify or alter trade records.

FIG. 31 is a schematic diagram illustrating the flow of information within the data processing system with respect to electronic mail which has been sent by a client to a broker representative. The e-mail function can be accessed from an icon (not shown) in the main menu. As shown, a client has generated an e-mail message which is carried by the Internet 300 as an incoming, unreviewed e-mail 302 received by an external e-mail server computer 304. The e-mail message is forwarded from the e-mail server 304 to the main server database computer 308. From this point on, the e-mail message is treated in the same way as a trade record which has been created by a broker representative and has been sent to the main database for recording and for subsequent forwarding to the branch manager for review. Data transfer for e-mail messages within the data processing system is achieved similar to the way in which the data processing system manages the transfer of data for trade records, except that the user does not have to access a separate data transfer screen, and the data transfer may take place by use of the various icons within the user interface screens or displays. For example, icons such as upload, download, forward, etc., are provided which allow an e-mail message to be transferred in the data processing system, and these data transfer functions are built into the applicable user interface screens. However, even e-mail messages are encrypted upon transmission and decrypted upon receipt. The main database records entry of the incoming e-mail message in a database, and forwards the recorded incoming e-mail message to a branch manager's computer 312 for review. For the incoming e-mail messages, the branch does not approve/disapprove the e-mail message, but rather simply indicates that the e-mail has been reviewed. If the branch manager observes something objectionable within the text of the incoming e-mail, for example, a client who wishes for a broker representative to guarantee a return on an investment, the branch manager would then take appropriate follow-up action (e.g., create an e-mail message to the particular broker representative) to ensure that this particular incoming e-mail message was properly handled by the broker to whom it was addressed. Accordingly, the functionality of the data processing system of this invention with regard to incoming e-mail messages is directed to the branch manager indicating review of the e-mail messages, and then allowing follow-up by the branch manager generating his/her own e-mail message which may comment on the received e-mail message. If a broker representative notes that an incoming e-mail message has been reviewed without additional comments by the branch manager, this would signify that no further discussion of this particular incoming e-mail message needs to take place. After the branch manager indicates review of the e-mail message, the message is sent back to the main database computer as an acted-on e-mail message 314. The main database computer 308 records the status of the reviewed e-mail message (i.e., the e-mail message being reviewed), and forwards the recorded acted-on e-mail message 316 to the representative's computer 318.

The management of e-mail messages as described above occurs for each and every e-mail message which is directed to a particular broker representative. Of course, a broker representative could maintain a separate e-mail account for personal and non-business-type message traffic, such as e-mail generated between family and friends. Thus, the most efficient use of the data processing system of this invention is for the management of official e-mails between a broker representative and a client which contemplate the trade of a security.

FIG. 32 is a schematic diagram illustrating the flow of information within the data processing system with respect to electronic mail which has been sent by a client to a broker representative. E-mail which is sent from the broker representative requires the actual approval/disapproval of the branch manager. Thus, as shown here, a broker representative generates an e-mail message at the broker representative's computer 318. The unapproved e-mail message 322 generated by the broker representative is forwarded to the main database computer 308. The main database computer makes a record of this generated unapproved e-mail message and, upon request, forwards the recorded unapproved e-mail message 324 to the branch manager's computer 312. The branch manager indicates approval/disapproval of the e-mail message and the approved/disapproved e-mail message 326 is returned to the main database computer 308 for recording. The main database computer then completes the routing of the recorded and approved e-mail message 328 by forwarding it to the e-mail server 304. If the e-mail message is disapproved, it is returned to the broker who generated the message, shown as disapproved message e329. The e-mail server then forwards the approved e-mail message 328 to the Internet for ultimate receipt by the addressed client. E-mail generated by the broker which is not approved by the branch manager may also be placed in a file in the form of a compliance report document within the main database. This compliance report document is shown as block 330.

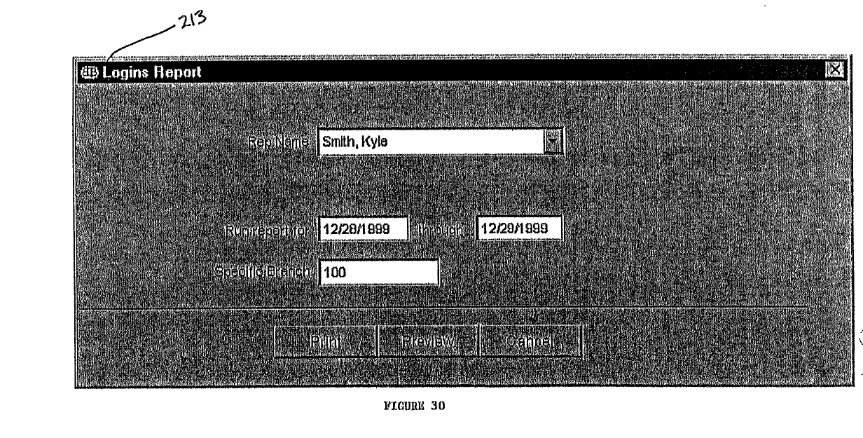

FIG. 33 illustrates a user interface screen or display showing the inbox tab of the e-mail function of the representative's version which allows the broker representative to receive e-mail, reply to the author of a received e-mail, or forward any e-mail messages. As shown, the display 330 has buttons for receiving incoming mail messages not read 332, replying to the author of an e-mail message 334, and forwarding a received e-mail message 336. A user selecting one of these three buttons activates data transfer of the particular e-mail concerned. As also shown in FIG. 33, this screen of FIG. 33 also displays e-mails received categorized by the sender of the e-mail, subject of e-mail, the date received, and whether or not the e-mail has yet been reviewed by the branch manager. Conveniently, the bottom portion of the screen also shows the full text of the e-mail which is highlighted or marked by the user. As well understood by those skilled in the art, a user can keep selected e-mail messages in the inbox, or may wish to delete an e-mail from the inbox and place it in another file such as a hold or trash file (not shown).

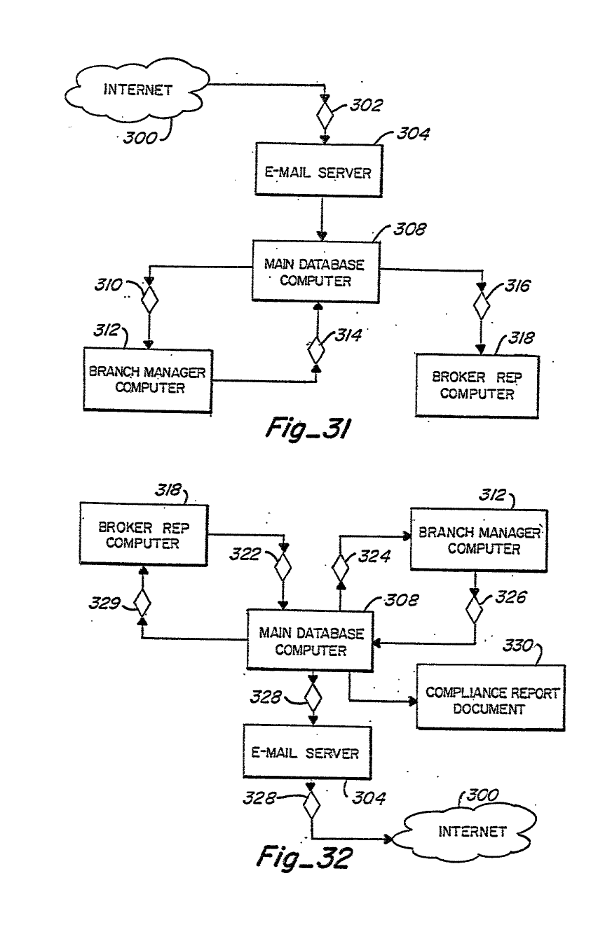

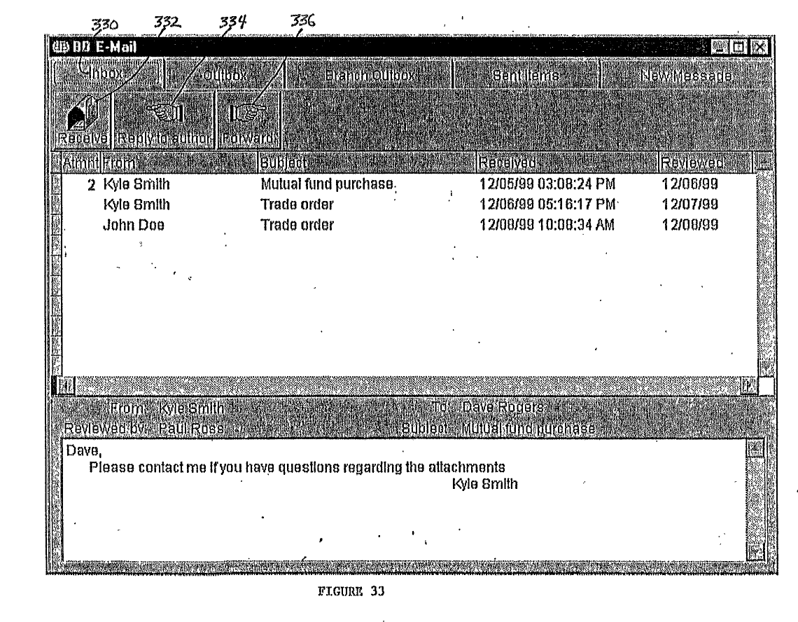

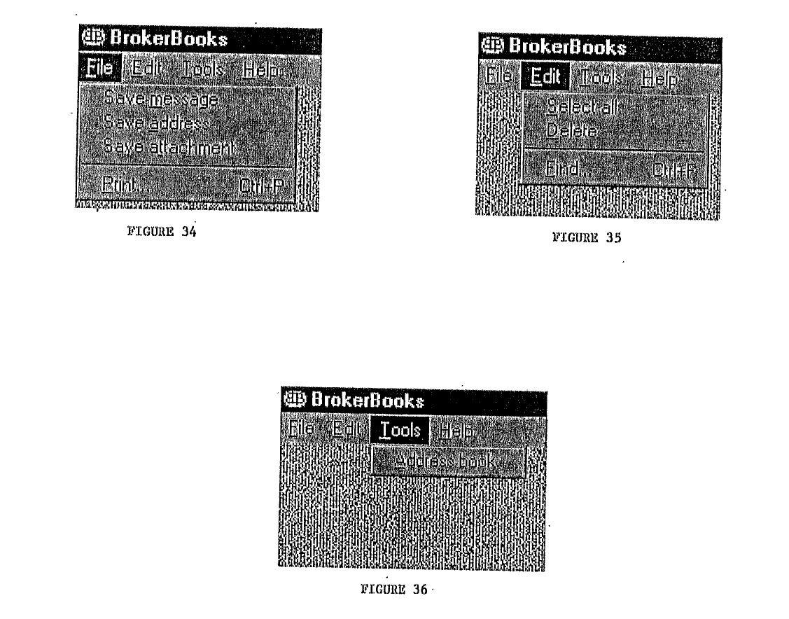

FIGS. 34-36 illustrate various menu bar options which may be displayed on the user interface screen or display corresponding to the inbox tab of the e-mail portion of the representative's version. As shown in FIG. 34, the pull down menu corresponding to the file option includes sub-options: save message, save address, save attachment, and print. FIG. 35 shows the pull down menu for the edit option including the sub-options of select all, delete, and find. FIG. 36 shows the pull down menu for the tools option which includes an address book sub-option.

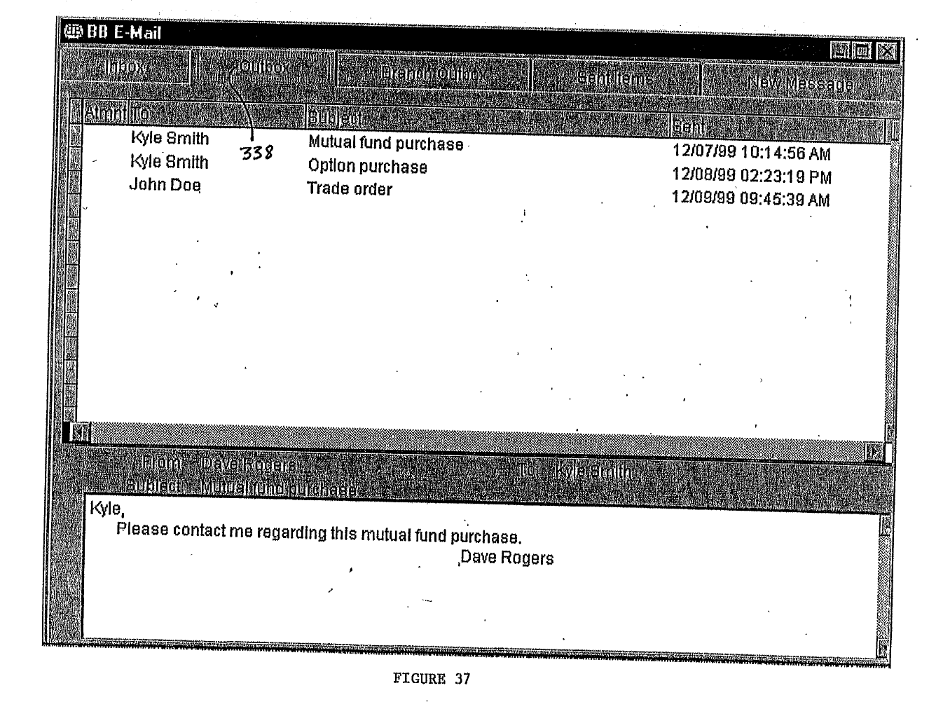

FIG. 37 illustrates the user interface screen or display showing the outbox tab 338 of the e-mail portion of the representative's version. As shown, the screen for the outbox lists all e-mail messages which have been generated by the broker representative but not yet transferred to the branch manager for approval. As with the inbox tab shown in FIG. 33, the outbox tab of FIG. 37 also includes a lower screen portion which can show the full text of a particular e-mail highlighted by the user.

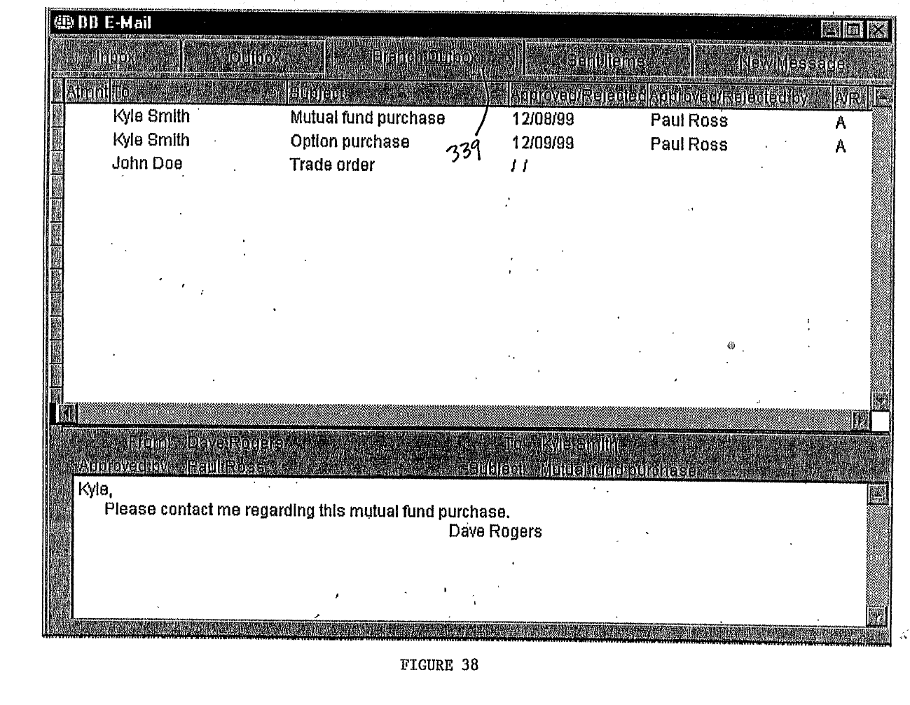

FIG. 38 illustrates the user interface screen or display showing the branch outbox tab 339 of the e-mail portion of the representative's version. As shown branch outbox 339 lists not only e-mail messages concerning one particular broker representative, but also other broker representatives within a particular branch. Occasionally, it may be necessary for a particular broker representative to check on correspondence sent to another broker representative, as two broker representatives may be serving mutual clients. Accordingly, the branch outbox tab allows a representative to review other recent correspondence directed to another broker representative within the same branch. The branch outbox 339 also has an approved/rejected column which indicates whether the correspondence has yet been approved or rejected by the branch manager. Although tab 339 is marked as a branch outbox tab, it has additional functionality in comparison to the outbox tab 338 in that tab 339 shows the particular status of communication by inclusion of the approved/rejected column.

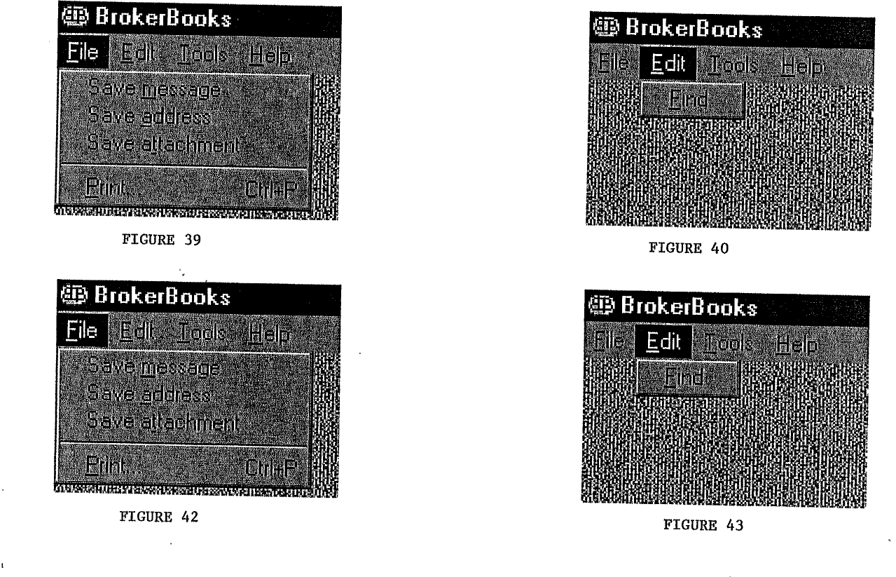

FIGS. 39 and 40 illustrate various menu bar options corresponding to the outbox tab of the e-mail portion of the representative's version. For FIGS. 39, the pull down menu corresponding to the file menu bar option includes the same sub-options as FIG. 35, namely, save message, save address, save attachment, and print. For the pull down menu corresponding to the edit menu bar option of FIG. 40, the sub-option includes a find function. The find sub-options for both FIG. 36 and FIG. 40 allow the broker representative to search for a particular e-mail by subject, date generated, etc.

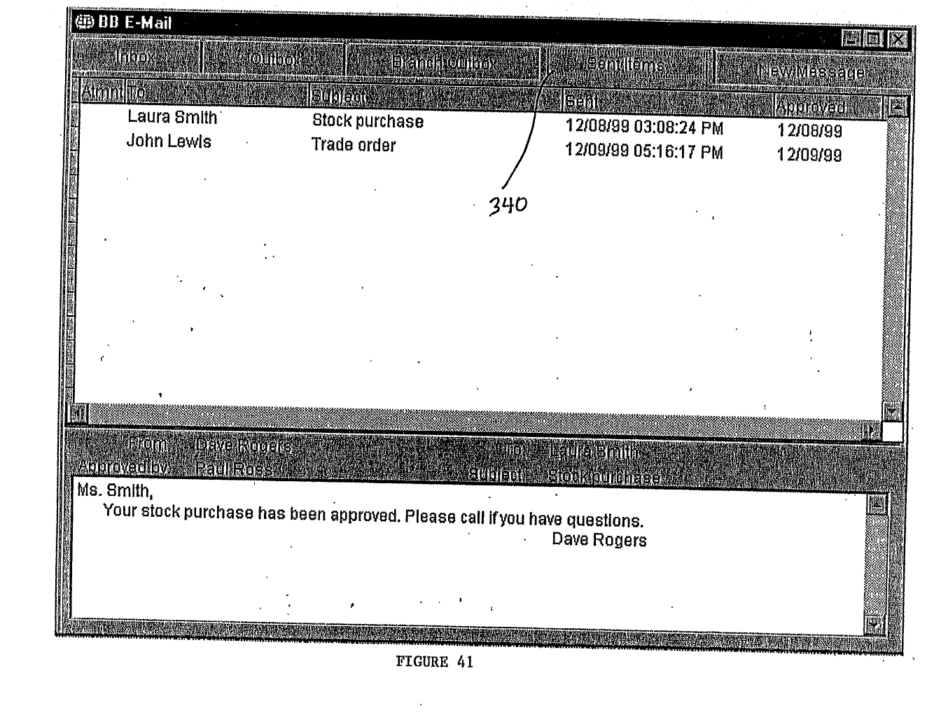

FIG. 41 illustrates a user interface screen or display 340 of the sent items tab of the e-mail portion of the representative's version. This screen is similar to the inbox and outbox tabs. This screen simply lists the e-mail messages which have been transferred from the broker representative's computer, either for approval by the branch manager, or those which have been approved and forwarded to a client. Accordingly, FIG. 41 has an indication of whether a particular e-mail message has been approved or disapproved. As with the inbox and outbox screens, the lower portion of the screen 340 also allows one to view the full text of a highlighted e-mail message.

FIGS. 42 and 43 illustrate some of the menu bar options which may be displayed corresponding to the sent items tab of the e-mail portion of the representative's version. As shown in FIG. 42, the file menu bar option has the same pull down menu and sub-options as the screens corresponding to the inbox and outbox tabs, and FIG. 43 illustrates the pull down menu corresponding to the edit menu bar option which also has the find function.

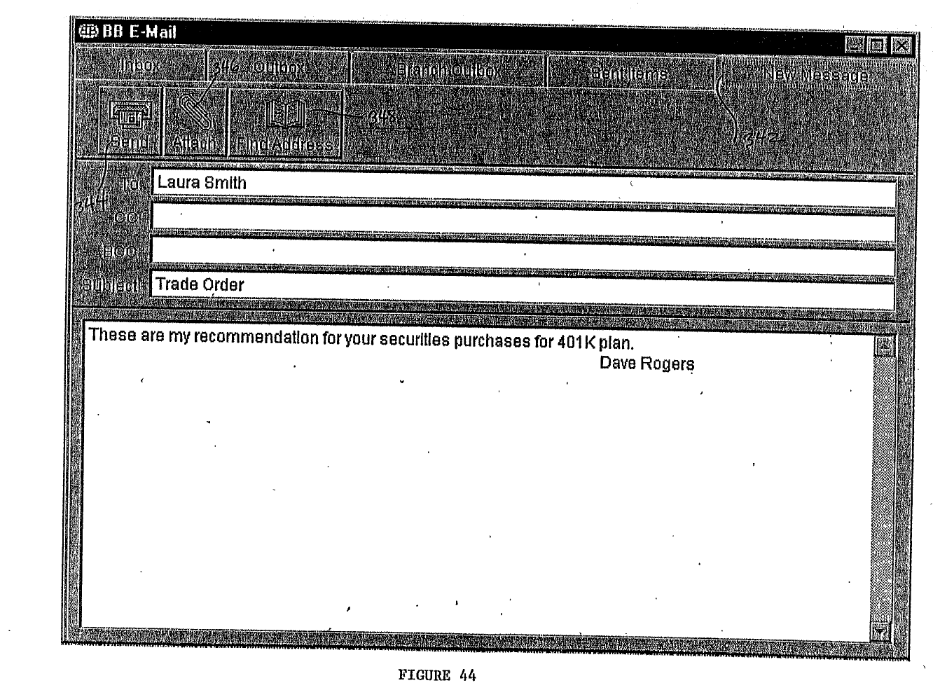

FIG. 44 illustrates the user interface screen or display corresponding to the new message tab of the e-mail portion of the representative's version. As shown, this screen 342 allows a user to create an e-mail message, send an e-mail message by clicking on the send icon 344, attaching a file to the e-mail message by clicking on the attach icon 346, and finding a particular e-mail address previously entered into the address book of the e-mail portion of the representative's version, by clicking on the find address icon 348.

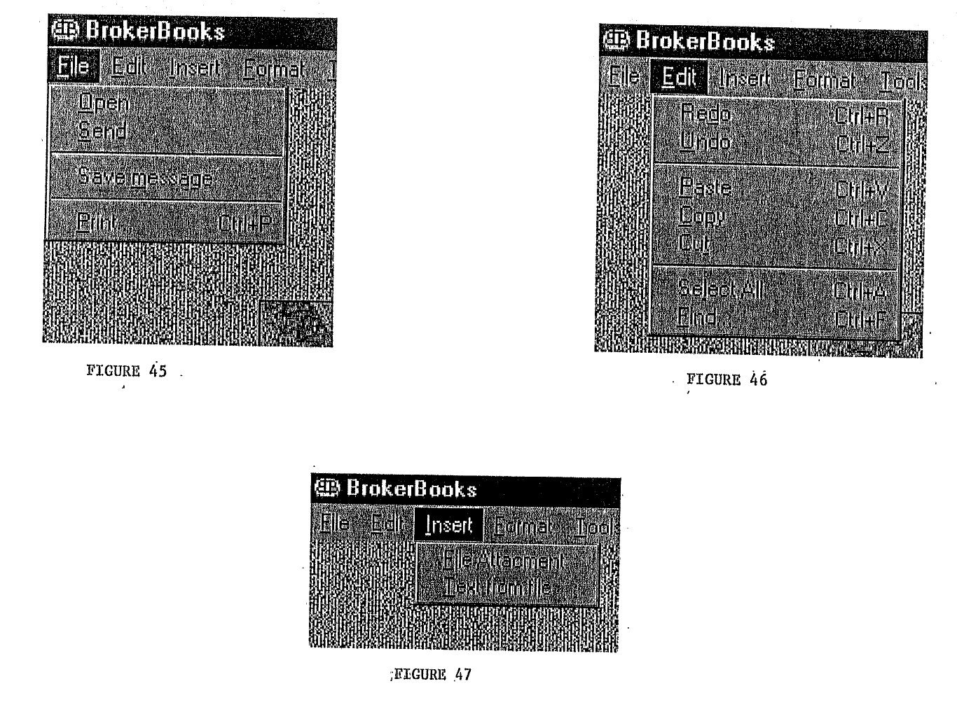

FIGS. 45-47 illustrate some of the menu bar options which may be displayed corresponding to the new message tab of the e-mail portion of the representative's version. As shown, the file menu bar option includes a pull down menu to include the sub-options of open, send, save message, and print. The edit menu bar option of FIG. 46 includes a pull down menu including the sub-options of review, undo, paste, copy, cut, select all, and find. The insert menu bar option of FIG. 47 includes a pull down menu having the sub-options of file attachment, and text from file.

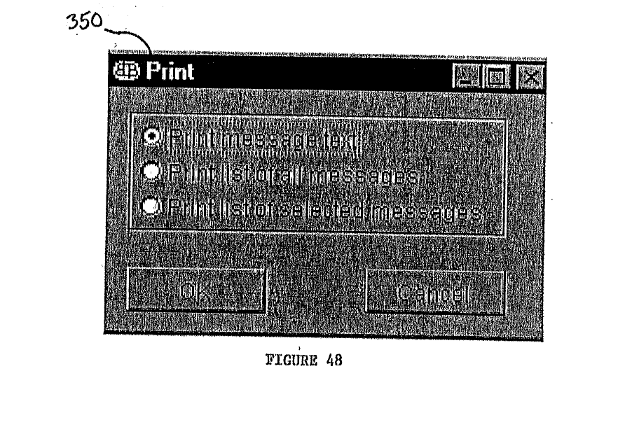

FIG. 48 illustrates a user interface screen or display for a print command 350 of the e-mail portion of the representative's version which the user activates in order to print a desired e-mail message.

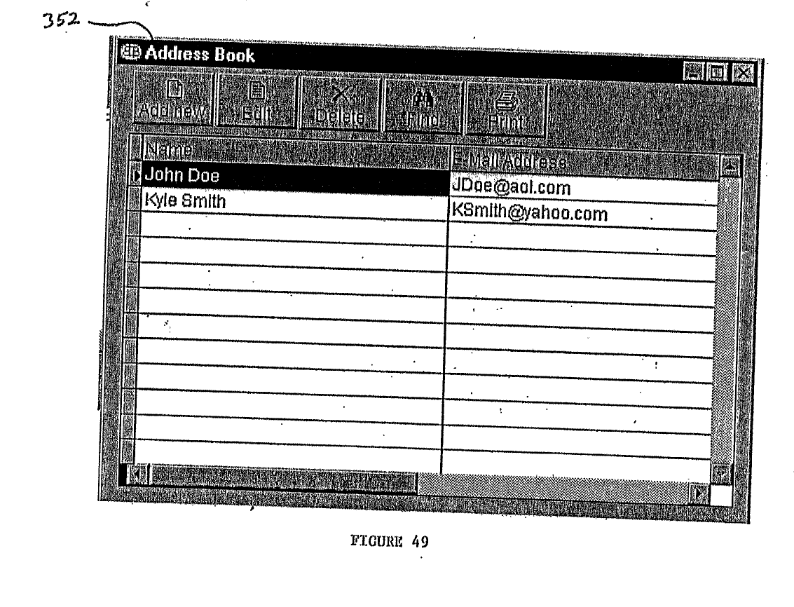

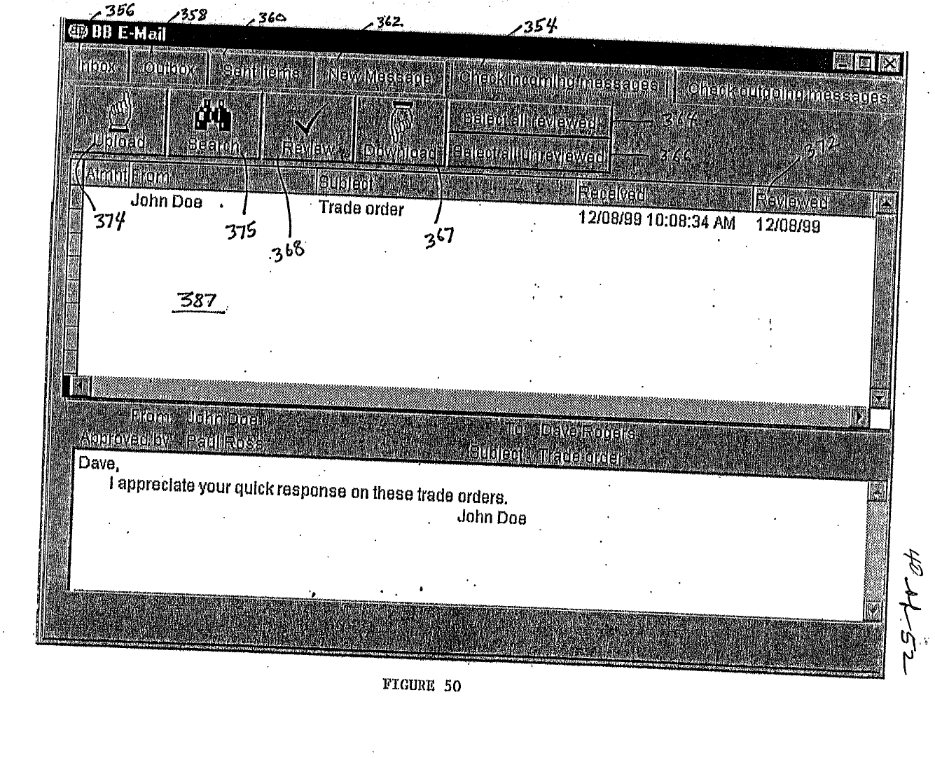

FIG. 49 illustrates a user interface screen for an address book 352 of the e-mail portion of the representative's version. As shown, an address book 352 may be created to store e-mail addresses corresponding to particular individuals or entities. The address book may be manipulated, with the functions shown in the icons on screen 352.

FIG. 50 is a user interface screen or display 354 illustrating the check incoming messages tab of the e-mail portion of the branch manager's version.

FIG. 50 also shows the text indicating the presence of inbox tab 356, outbox tab 358, and sent items tab 360. These three tabs exist in the branch manager's version and have essentially the same functionality as discussed above with respect to the broker representative's version; therefore, a discussion thereof will not be repeated. Within the check incoming messages tab 354, the user has the option of selecting all reviewed messages 364, or selecting all unreviewed e-mail messages 366. Activating the select all reviewed button 364 allows the branch manager to review all reviewed e-mail messages. Activating the select all unreviewed e-mail messages button 366 allows the branch manager to view all unreviewed e-mail messages which have been forwarded from the broker representative's computer to the main server database, and which are awaiting for review by the branch manager. However, the branch manager must actually transfer the unreviewed e-mails by also clicking on the download button 367 which downloads the unreviewed e-mails from the main server database to the branch manager's computer. After reviewing the various e-mail messages, the branch manager would highlight the particular e-mail message, and then click on either the review button 368, the particular e-mail message would then have an indication in the reviewed column 372 as to the branch manager's action. In order to forward the e-mail messages just acted on, the branch manager would then select the upload icon 374 in order for the action to be recorded in the main database. In order to timely and effectively handle the review of incoming e-mail messages, the branch manager must periodically log on to the data processing system and check incoming messages through the check incoming messages tab 354, and then download the messages.

Under most circumstances, a branch manager would indicate review of a particular e-mail message, and then immediately click on the upload button 374 to make the message available for sending the e-mail message back to the broker representative. In some circumstances, however, the branch manager may wish to wait to download the e-mail message whereby the reviewed e-mail message will remain in the local database of the branch manager's computer.

FIG. 50 also shows search icon 375, further discussed below.

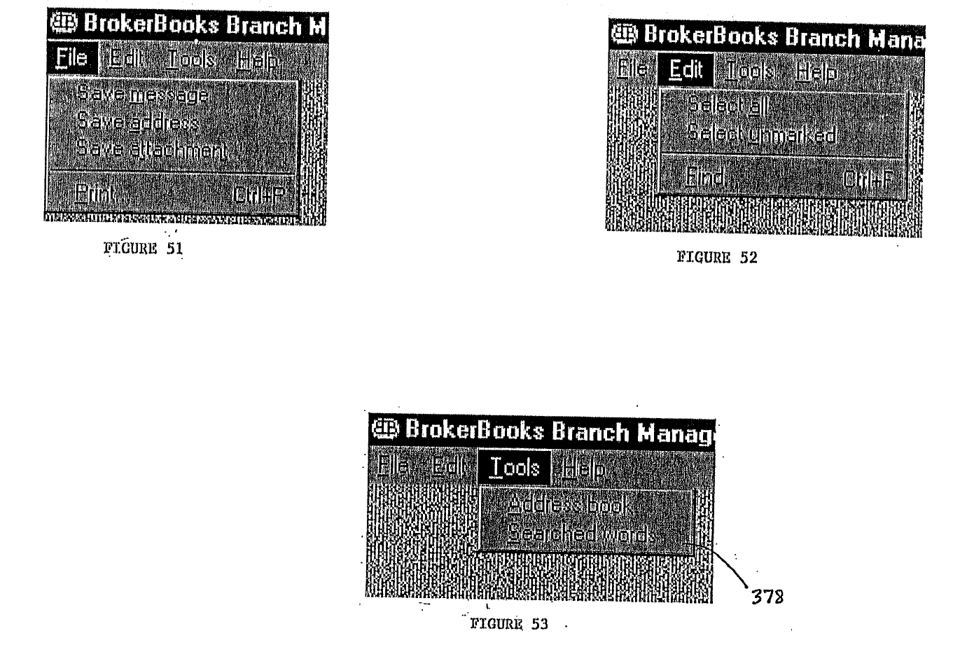

FIGS. 51-53 illustrate menu bar options which may be displayed corresponding to the check incoming message tab 354 of the e-mail portion of the branch manager's version. FIG. 51 illustrates the pull down menu corresponding to the file menu bar option. FIG. 52 illustrates the pull down menu corresponding to the edit bar option, and FIG. 53 illustrates the pull down menu for the tools menu bar option. The select all sub-option in the pull down menu of FIG. 52 allows a user to execute a command with respect to all those e-mail messages which have been highlighted or marked. The select unmarked sub-option in the pull down menu of FIG. 52 allows a user to execute a command with respect to all those e-mail messages which have not been marked or highlighted. The searched words sub-option 378 in the pull down menu of FIG. 53 allows a branch manager to search for particular words or phrases which are found in any e-mail message either sent to a broker representative from a client, or sent from a broker representative to a client. The SEC guidelines requires the monitoring of particular words or phrases used in any securities transactions.

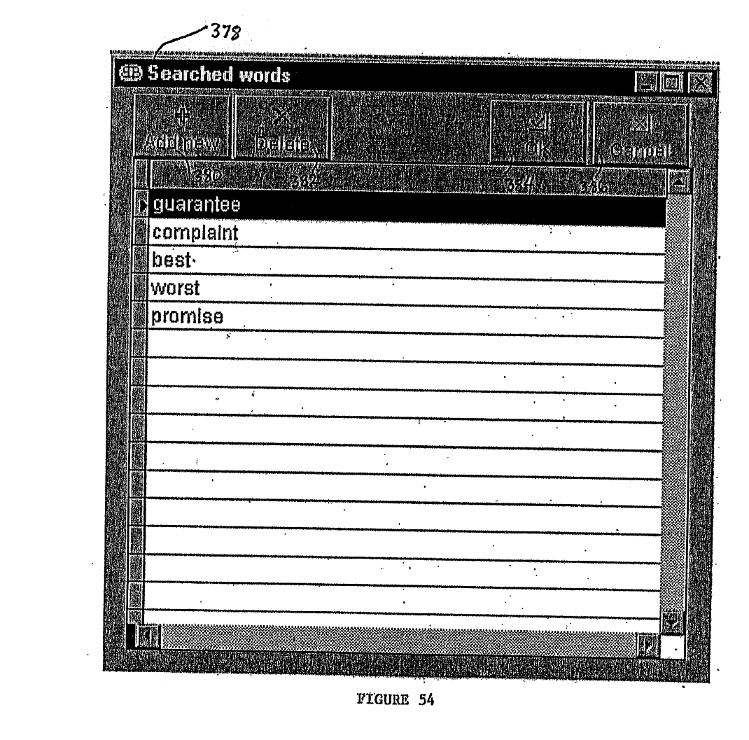

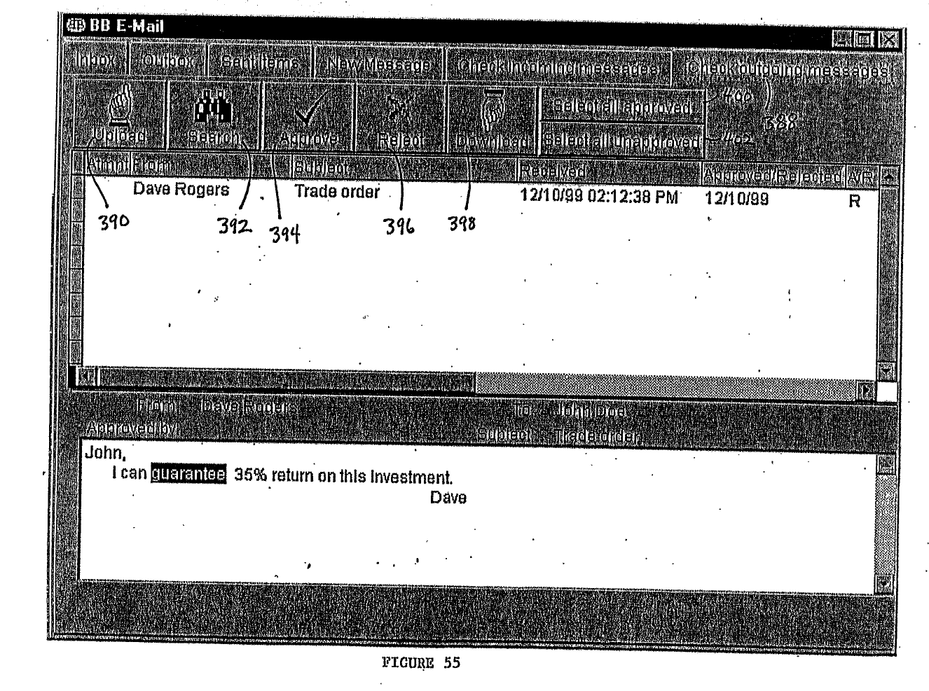

FIG. 54 illustrates a user interface screen showing the searched words function 378 which allows e-mail message text to be scanned for usage of any words or phrases, as identified by the user who enters the words or phrases in the space available within the screen. For example, a branch manager may have a listing of those words which the SEC requires to be monitored in all e-mail transactions. As necessary, the branch manager may update this list by adding new words, or deleting words or phrases. Adding new words may be completed by activating the add listing button 380, while words or phrases to be deleted can be done so by highlighting the particular word or phrases and then activating the delete button 382. Pressing the OK button 384 indicates that the searched words listing is updated according to the user's desire. Activating the cancel button 386 will cancel any previous changes just made to the listing.

Once a branch manager has created the searched words listing as shown in FIG. 54, the branch manager would click on the search icon 375 of FIG. 50 in order to conduct a search of the words or phrases which appear in searched words listing. This search can be conducted with respect to reviewed, unreviewed, approved or unapproved e-mail messages. If the search has found any e-mail messages which include the targeted words or phrases, such e-mail messages will be identified and listed in the upper large text box 357 of the screen 354 of FIG. 50 so that the branch manager can review such messages. As necessary, the branch manager can then conduct necessary follow-up actions to handle any flags which could be raised by use of the searched words or phrases.

FIG. 55 illustrates a user interface screen or display showing the check outgoing messages of the e-mail portion of the branch manager's version. As shown, FIG. 55 is the same as FIG. 50 in terms of the options provided to the branch manager for handling outgoing e-mail messages sent from a broker. Accordingly, the check outgoing messages tab 388 includes an upload button 390, a search button 392, an approve button 394, a reject/disapprove button 396, a download button 398, a select all approval button 400, and a select all unapproved button 402. In accordance with the discussion set forth above with respect to FIG. 32 (e-mail sent from a broker), a branch manager would download all unapproved outgoing messages, review the messages, signify approval/rejection, and then upload the acted-on e-mail messages. A search can be conducted for outgoing messages by activating the search button 392. The branch manager could also review all previously approved trades by clicking on the select all approved button 400.

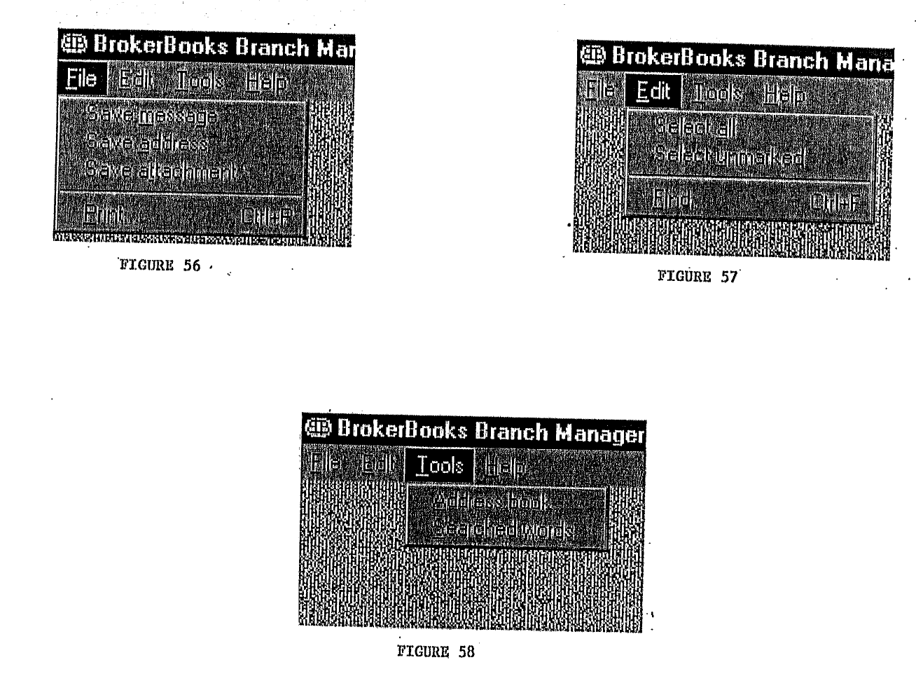

FIGS. 56-58 illustrate the various menu bar options and pull down menus which may be displayed on a user interface screen or display corresponding to the check outgoing messages tab of the e-mail portion. The menu bar options and pull down menus shown in FIGS. 56-58 mirror those found in FIGS. 51-53.

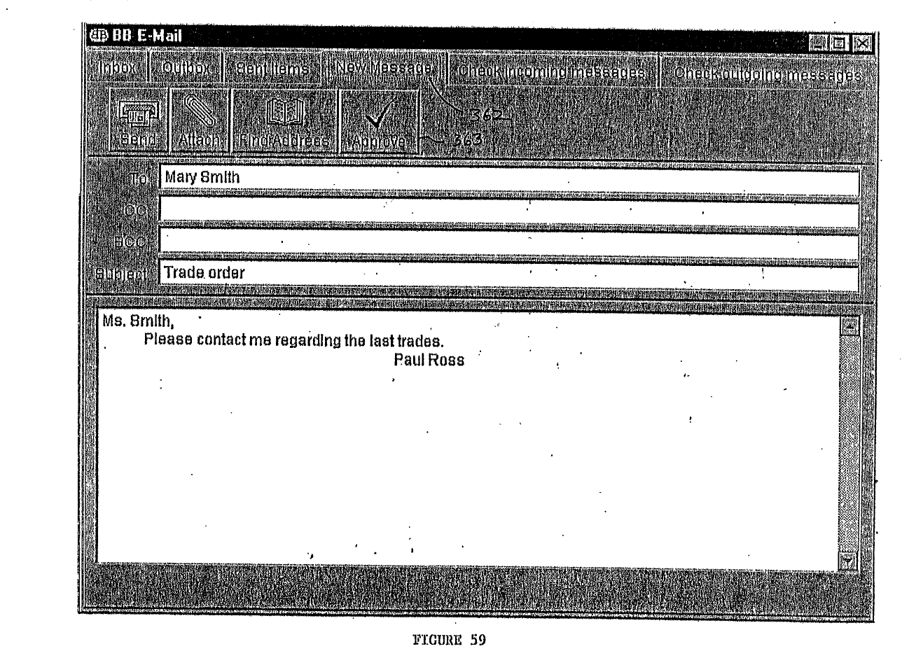

FIG. 59 illustrates a user interface screen or display showing the new message tab 362 of the e-mail portion of the branch manager's version. The new message tab 362 has essentially the same functionality as the new message tab 342 of the broker representative's version. Specifically, the new message 362 includes a send function, an attach function, and a find address function. Additionally, the branch manager's version has an approve button 363 which the branch manager utilizes in approving his/her own new e-mail message which has been created. In other words, even for message traffic which is created by a particular branch manager, the branch manager must have approval of his/her own message generated. Of course, if a particular branch manager creates a new message and then decides that such message cannot be approved, instead of creating the message and then marking it with a rejected flag, the branch manager would simply start over and create a new message which could be approved. Also, it is within the spirit and scope of this invention to provide functionality in which branch managers periodically check one another's created messages for compliance. Accordingly, the branch manager's version could have functionality which would allow a branch manager to be designated as a reviewing branch manager for a period of time, and then such reviewing branch manager would review the e-mail messages created by other branch managers within a brokerage. The particular reviewing branch manager could be rotated among the branch managers as desired. In the case where a branch manager was tasked with reviewing e-mail message traffic created by another branch manager, a reject button could also be provided on tab 362 which would enable the branch manager reviewing a particular e-mail message to reject the message in the same manner as use of the reject button 396.

B. Second Embodiment

As discussed briefly above, the second embodiment simply incorporates the data processing system of this invention by user access to a website, and a central or main web server computer handles the functionality of the system through software loaded on a web server computer.

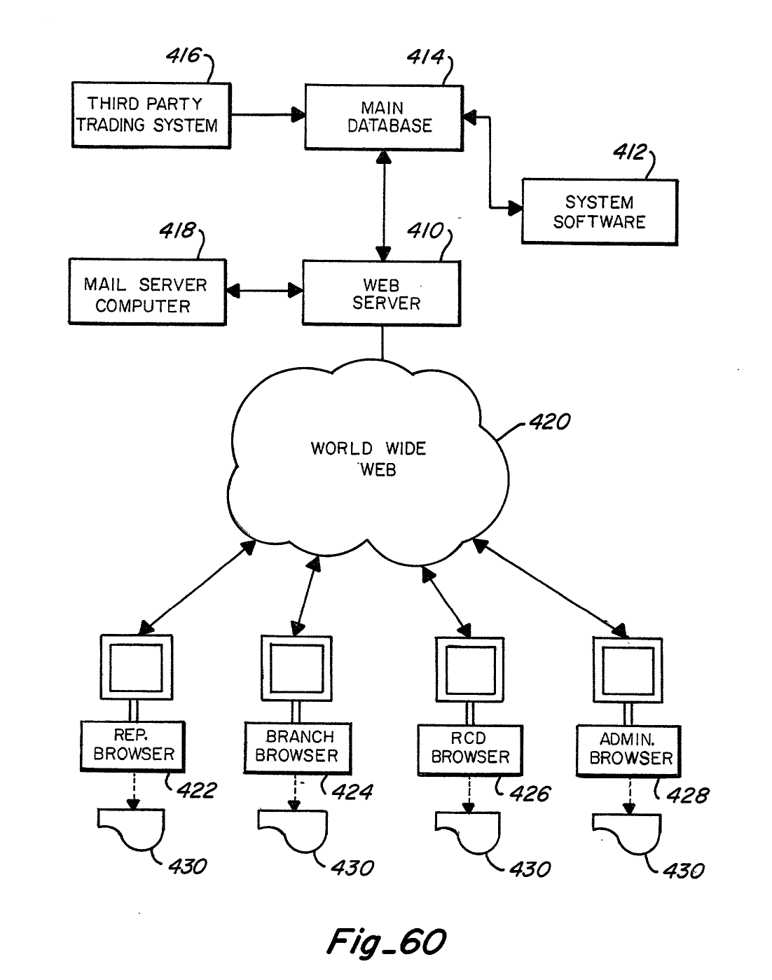

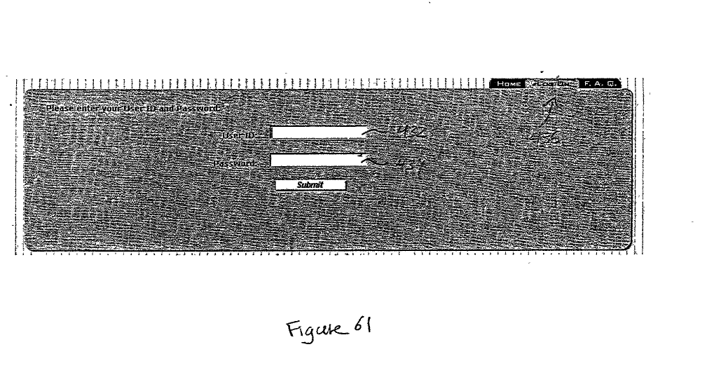

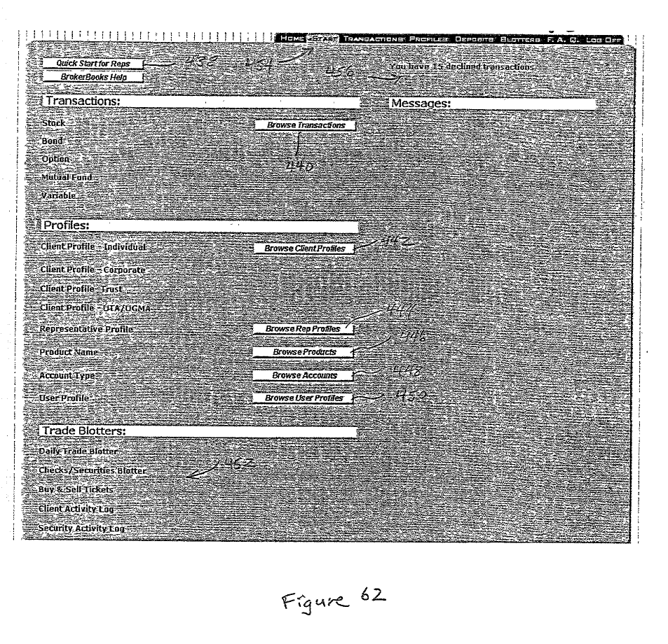

Referring now to the schematic diagram of FIG. 60, the data processing system 10 is illustrated in a second embodiment. First, there is a web server computer 410 which can be in the form of a sufficiently powerful computer having a central processing unit, main memory, disk storage, and other features as well understood in the art. The web server computer 410 is also equipped with the necessary hardware which allows it to communicate with other computers via the worldwide web 420. The web server computer 410 hosts the system software 412 which includes the entire set of program instructions or software for controlling the functionality of the data processing system. Thus, the system software 412 includes the separate functionality for what was previously referred to in the first embodiment as the various user versions of the software (broker representative, branch manager, and regional compliance director). The system software 412 also has the same capability as the functions related to the DBMS administrator portion, and the TCP listener. The main database 414 may be similar to the database of the first embodiment, and could include Oracle™ or SQL Server™ type databases. System software 412 directs storage and data manipulation within the main database 414.

An additional feature of the web browser version is the ability for an outside or third party organization to send, via e-mail, FTP or other agreed upon protocol, an electronic data file that contains trade information that was previously entered into the organization's own electronic or online trading system. A third party's trading system 416 is shown in FIG. 60. Therefore, in terms of data entry, the second embodiment of this invention is able to also handle data entry from third parties who wish to enter trade information through their own systems. This data entry from a third party is also achieved by secure communication means including data encryption/decryption. Such data can be automatically loaded into the main database 414, thereby eliminating the need for a separate communication from the third party to the broker representative. The data entered by the third party organization can be formatted in the same manner in which trade data is entered from broker representatives. The third party organization may be given the option to send the trade data as often as it desires, and the data will be automatically loaded into the main database 414. Although the third party trading system 416 is depicted as transferring data directly to the main database 414, as discussed above, the data can also be entered via e-mail through the worldwide web, or even a separate LAN setup for third party trading systems. Computers 422, 424, 426 and 428 represent the computers of the different user types which may wish to access the data processing system, just as in the first embodiment. Although separate computing devices are shown, it shall be understood that because the second embodiment is a web browser version, a single computing device could be used by different users who are given their respective user access levels. Also illustrated are various peripherals or output devices 430 which may include a printer or other device to print data.

FIG. 60 also illustrates a separate mail server computer 418. As understood by those skilled in the art, it is often desirable to have a separate mail server computer to handle basic e-mail communications; however, it shall be understood that the web server computer 420 could handle e-mail communications as well.

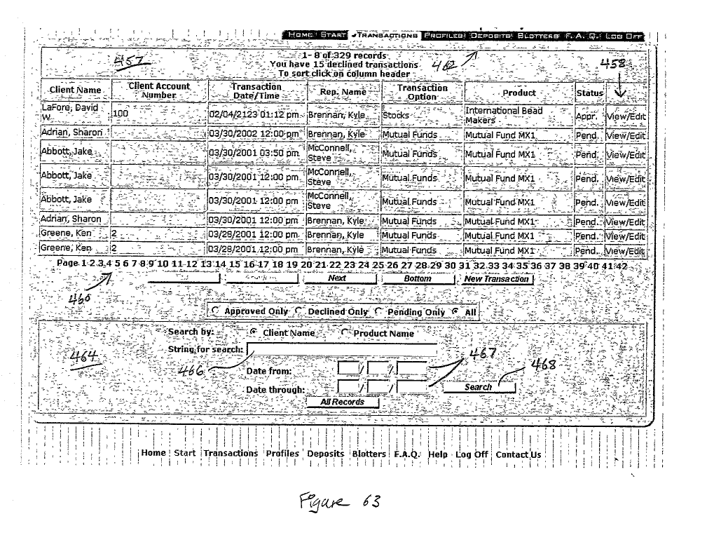

FIGS. 61-66 specifically disclose certain features of the second embodiment. It should be understood that unless otherwise specifically mentioned, the functionality illustrated and discussed in detail with respect to the first embodiment also applies to the second embodiment.

The description of the figures which follow are sample user interface screens or “screen shots” which illustrate the functionality of the web browser version as seen by the user. Again, it shall be understood that the web browser has the same functionality as the windows/first embodiment, and these figures are provided to reemphasize the functionality, and also to discuss additional functionality.

Referring now to FIG. 61, the web browser version also includes a user interface screen allowing the user to enter their user ID at block 432, and their password at block 434. This is preferably the first user interface screen which would appear after a user accesses the website. As also shown in FIG. 61, at the upper right portion thereof, a set of tabs 436 are provided to navigate through the website. Tabs 436 include the options of the home page, logging on, or frequently asked questions. The logon screen is the one shown in FIG. 61.

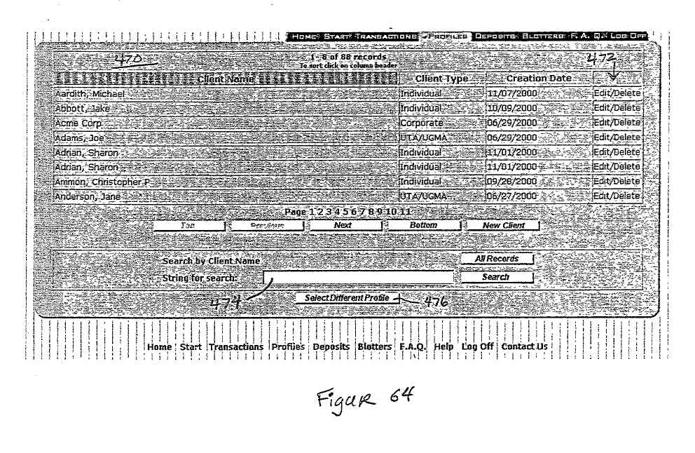

FIG. 62 illustrates a start screen which enables a user to select from a number of options. Tab/button 438 refers to a quick start up instructions for representatives to guide them in using the data processing system. The primary options offered to a user include browsing transactions at tab/button 440 which enables a user to view various transactions or to enter new transactions including stocks, bonds, options, mutual funds, and variables. A user can also simply click on the name of the transaction on the left side of the screen to view or enter transactions.

The browse client profiles button 442 enables a user to view the various profiles available on the system to include client profiles including individuals, corporations, trusts, and others. Other buttons shown on this screen include browse representative profiles 445, browse products 446, browse accounts 448, and browse user profiles 450. Clicking on these buttons allows a user to browse the data in the respective areas, as further discussed below. Additionally, this screen allows a user to view various reports/blotters, to include trade blotters, checks/securities blotters by clicking on the desire blotter. The trade blotters also include the buy and sell tickets, and the various activity logs including the client activity log and security activity log. These blotters are indicated generally at 452. Thus, rather than using pull down menus as used with the first embodiment, the browser version simply utilizes the start screen from which users can navigate through the site. In lieu of the button/hyperlinks, the various tabs generally indicated by 454 also allow user to navigate through the website. Also shown on FIG. 62 is a message 456 which indicates to the user the number of declined transactions. For example, if a broker representative requested approval of a particular trade, this start screen would indicate the number of declined transactions which the representative needed to review. These specific declined transactions would include those in which the branch manager had reviewed, and was providing an initial declined status back to the broker representative.

FIG. 63 illustrates a sample browse transaction screen. As shown in the table 457, the information available includes the client name, client account number, transaction date/time, representative name, transaction option, product, and status. At 458, the user has the option to view a particular transaction, or to edit a particular transaction. The user also has the option to sort data by clicking on the particular column header. For example, if the user wanted to view an alphabetical listing of all client names, the user would click on the header entitled “Client Name” which would result in all of the client names being provided in an alphabetical listing. The particular data which a user can view on this browse transaction screen is, of course, based upon the user's access level. Thus, if a broker representative was viewing the browse transaction screen, the only listing of client names which would appear would be those particular clients of the broker, or the clients of other brokers whom the broker had been given authorization to view. In some circumstances, a broker can be authorized to view not only his/her own clients, but the clients of other brokers as well. If a branch manager was viewing the browse transaction screen, the branch manager would be able to view all of the clients of his/her particular branch, because the branch manager presumptively has access to all of the client names of his/her particular branch. To sort data in other ways, the user would click on the other respective column headers. For example, the user can also sort data by client account number, transaction date/time, representative names, transaction options, products, and statuses. For client account numbers, clicking on this column header would allow the user to view all transactions based upon sorted client account numbers. These client account numbers could be listed numerically from highest to lowest, lowest to highest, or any other desired numerical pattern. For transaction dates/times, the data in this column could be listed by showing oldest to newest transactions, newest to oldest transactions, or other desired patterns of dates/times. For representative names, transaction options, products, and statuses, each of these columns may be sorted alphabetically, or other desired arrangements.

FIG. 63 also illustrates the ease in which a user may navigate through website by clicking on a particular page at 460, or accessing another screen at tabs 462. Box 464 allows a user to search various types of files either by a client name or product name. Additionally, the search may be conducted for approved transactions, declined transactions, pending transactions, or all transactions. The user would enter the desired dates at boxes 467 to search a specific time frame. The user would then execute the search by clicking on search button 468. This browse transaction capability shown in FIG. 63 allows not only broker representatives, but all types of users the ability to quickly access data. As with the first embodiment, depending upon the user access level, certain individuals may only be able to edit a particular transaction. For example, the compliance directors may be able to view a transaction, but would not be able to actually edit the transaction. Therefore, data is made readily available to all types of users; however, the same procedures as set forth at the first embodiment apply to a second embodiment in terms of what a particular user may do with data within the system.

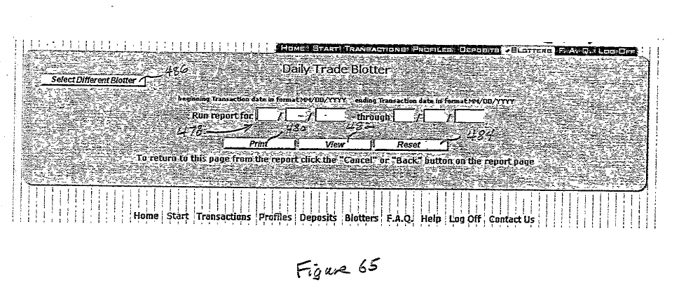

FIG. 64 illustrates a sample browse profiles screen. As shown, the profiles screen may include table 470 including client name, client type, and creation date information. The user would also have the option to edit or delete a particular profile by clicking on the corresponding button 472. As with the transaction screen of FIG. 63, a user would be able to edit or delete a profile entry only in accordance with their authorized user access level. Box 474 also allows a user to search various client names by entering the correct text in box 474. If a different type of profile were desired (such as a product profile), then the user would simply click on button 476 which would allow the user to navigate to the desired profile. A user can also sort data by clicking on the desired column header (client name, client type and creation date).

FIG. 65 illustrates another screen shot or user interface screen illustrating the manner in which a user can select a particular daily trade blotter. A user would enter the desired dates in box 478, and then would choose to print the report for that period at 480, view the report at 482, or reset the screen for a different time frame at reset button 484. The user also may select a different blotter at button 486. The second embodiment is the same in terms of the type of report data which may be extracted from the data processing system of this invention.

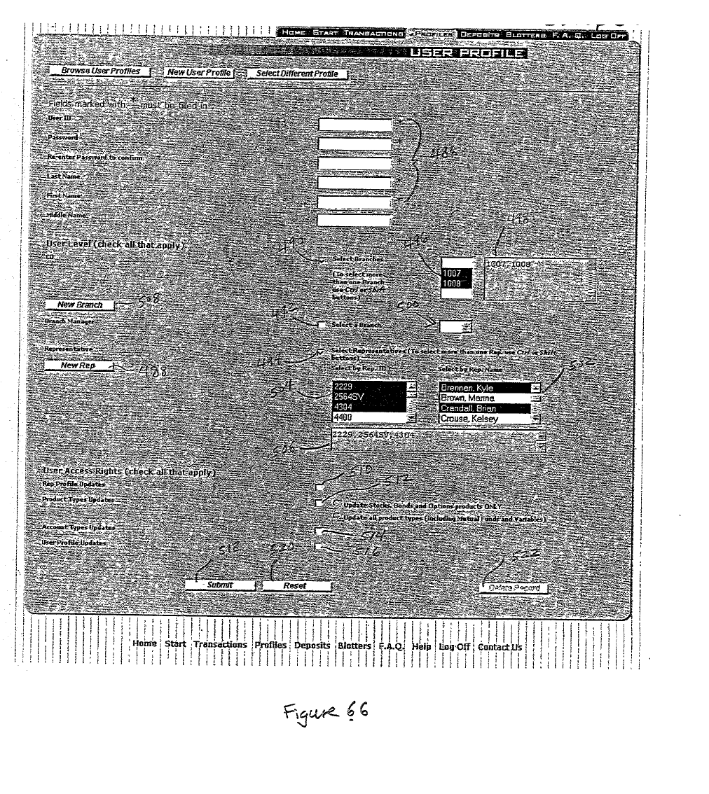

FIG. 66 illustrates a sample screen shot illustrating how an administrator may add various users to the system, update user access levels, change passwords, delete system users, among other functions. Thus, this particular screen replaces the corresponding DBMS functionality of the first embodiment. First, the administrator would enter the data at blocks 486 corresponding to the particular user's information, including user ID, password, last name, and first name. For new users other than broker representatives, the administrator can commence creation of user access by entering this data, and completing the additional steps outlined below. If a new broker representative is to be added, the administrator would first click on the new representative button 488 which would provide another screen (not shown) allowing the administrator to add the comprehensive data corresponding to the broker representative's particular profile. This information, as discussed above with respect to the first embodiment includes all of the broker representative's personal information, as well as the broker representative's licenses, and other professional credentials. For new users, once the administrator had completed blocks 486, the administrator would then select the type of user access for the particular user. Thus, the administrator could check box 490 if the new user was to be compliance director, box 492 if the new user was to be a branch manager, and box 494 if the new user was to be a broker representative. If the new user was to be compliance director, the administrator would then highlight the particular branch(es) for which the compliance director was to have access. The particular branch(es) would be shown in the pull down menu 496. The selected branch(es) would then appear in confirmation box 498 after the administrator had selected the desired branch(es) from menu 496. If the new user was to be a branch manager, the administrator would then highlight the particular branch shown in pull down menu 500. It is generally presumed that a branch manager would only be in charge of one particular branch. Therefore, there is not a separate confirmation box, as is the case of box 498 which lists the selected branch(es) corresponding to the particular compliance director. If the user was to be a broker representative, the administrator would highlight the particular representative's name in box 502, or the particular representative's representative ID in box 504. The administrator could select more than one particular broker representative name or representative ID. For example, one particular representative could be given authorization to act on behalf of other broker representatives. Thus, the particular broker representative appearing in blocks 486 would correspond not only to the same representative appearing in blocks 502/504, but the particular representative appearing in blocks 486 could also be given authorization to act on behalf of other representatives as chosen by the administrator. The representative(s) chosen by the administrator would then appear in the selection box 506. Another example in which a system user might be given authorization to enter trade data for one or more broker representatives would be if a particular administrative assistant or secretary of a brokerage house worked for a number of broker representatives. This administrative assistant/secretary could be entered as a user in the blocks 486, and then be given authorization to act on behalf of one or more broker representatives listed in menus 502/504. Thus, the system would treat this particular user as a broker representative in terms of the basic user authorizations. As discussed above with regard to the first embodiment, the respective users in the second embodiment (administrators, compliance directors, branch managers, and representatives) have the same respective authorization levels in the second embodiment. If it is desired to add a new branch, then the administrator would click on the new branch button 508 enabling the administrator to create a profile for the new branch. Once created, the new branch would appear in the pull down menu 500. In addition to the basic user access rights discussed above with respect to the first embodiment, the second embodiment also allows some flexibility in adding specific types of user access rights. Box 510 allows the administrator to provide a particular user the ability to update the broker representative profiles. Checking box 510 would enable the particular user identified in blocks 486 to then update broker representative profiles. Box 512 allows the administrator to give access to a particular user in terms of updating particular product types. Box 514 enables the administrator to provide access for a user to update account types. Box 516 allows the administrator to provide access for a user to update user profiles. Any one of these boxes 510, 512, 514, and 516 may be checked by the administrator to provide access rights to the particular user appearing in blocks 486. After the administrator is satisfied with the entry of data as discussed above, the administrator would then click on the submit button 518 which would then add the particular user. If the administrator wishes to update or edit information regarding an existing user, the administrator would access the browse user profile screen, FIG. 62, box 450, and select the desired user. The previously entered information regarding that particular user would appear on the screen. For example, if the administrator wished to update user access rights for a particular broker representative, the user profile would be selected from the browse profile screen and the broker representative information would appear on the screen as originally submitted. Then, the administrator could change user access rights, could designate the particular broker representative also as a branch manager, or could delete the broker representative as a representative and only designate that person as a branch manager or compliance director, etc. The administrator would then click on the submit button 518 which would result in an update in the status of the particular user. Reset button 520 is also provided which simply allows the administrator to clear the screen of all data entered, and begin with new data entry. Finally, the administrator has the capability to delete an entire user record by clicking on delete record button 522 after previously entering the user to be deleted in blocks 486.

The e-mail portion for this second embodiment has the same functionality as the first embodiment. As discussed with respect to FIG. 60, a separate mail server computer 418 may be used in conjunction with the web server 410 in order to handle incoming and outgoing e-mail transmissions. All incoming e-mail messages to a broker or a branch manager are reviewed by a branch manager who has the option of attaching a message to the incoming email requesting that the recipient contact the branch manager regarding the content of the incoming e-mail. Thus, incoming messages are reviewed for content. As for outgoing e-mail messages, whether they originate from a branch manager or broker representative, it must be approved by a branch manager before being sent. As with the first embodiment, incoming or outgoing e-mail cannot be deleted, and is stored in the main database 414.

This invention has been described in detail with reference to particular embodiments thereof, but it will be understood that various other modifications can be effected within the spirit and scope of this invention.

What is claimed is:

1. A data processing system for managing broker transaction information in compliance with governmental regulations, comprising:
(a) computer processor means for processing data;
(b) storage means for storing said data on a storage medium;
(c) communication means for transmitting data in a secure environment to and from various remote locations; and
(d) computer software means for creating trade data concerning a particular trade in the form of a trade record, reviewing said trade data and approving/disapproving the trade record, and maintaining security measures for said data processing system to prevent unauthorized access and use of said trade data.

2. A data processing system, as claimed in claim 1, wherein said computer software means further comprises:
means for inputting and storing system information on said storage means.

3. A data processing system, as claimed in claim 1, further comprising:
means for monitoring the modification of trade data in respective trade records which are created by said computer software means.

4. A data processing system, as claimed in claim 1, further including:
means for monitoring log-ins to said data processing system.

5. A data processing system, as claimed in claim 1, further comprising:
means for monitoring the activity of a particular broker representative who enters trade data through said computer software means.

6. A data processing system, as claimed in claim 1, further including:
means for outputting information regarding a particular trade.

7. A data processing system, as claimed in claim 1, further including:
means for creating and outputting daily trade blotter information.

8. A data processing system, as claimed in claim 1, further including:
means for creating and outputting checks/securities blotters.

9. A data processing system, as claimed in claim 1, further including:
means for creating and outputting buy and sell tickets.

10. A data processing system, as claimed in claim 1, further including:
means for creating and outputting client activity logs.

11. A method of managing and processing broker transaction data comprising the steps of:
entering and recording trade data into a main server database of a data processing system;
creating data files in the main server database corresponding to the entered trade data;
monitoring all modifications made to the entered trade data residing in the respective data files; and
reporting all said modifications made to the trade data in a display generated by the data processing system.

12. A method, as claimed in claim 11, further including the steps of:
transmitting data within said data processing system by secure transmission means.

13. A method of managing and processing broker transaction data, said method comprising the steps of:
inputting broker transaction data by a computer logged onto a website linked to a data processing system, said broker transaction data reflective of a trade of a security;
recording the transaction data on the main database in the form of an original trade record;
posting the original trade record on a user screen for availability by a branch manager who then approves/disapproves the original trade record;
posting the approved/disapproved original trade record by the branch manager on the main database;
posting the approved/rejected original trade record on a user screen for availability by a broker representative; and
wherein said method takes place in the data processing system, and said transaction data and said trade record are manipulated electronically.

14. A method, as claimed in claim 13, wherein:
transfer of the transaction data and the trade record is conducted in a secure environment by encryption and decryption.

15. A method, as claimed in claim 13, further including the step of:
changing an element of data on the original trade record; recording the change of data in the original trade record; and
creating a display in the form of a comparative report showing the original trade record, and the original trade record as amended with the changed data element.

16. A method, as claimed in claim 13, further including the steps of:
managing a plurality of trade records; and
creating an output reflective of the plurality of trade records in the form of a desired report.

17. A method, as claimed in claim 16, wherein said desired report is a daily trade blotter.

18. A method, as claimed in claim 16, wherein:
said desired report is a check/securities received blotter.

19. A method, as claimed in claim 16, wherein:
said desired report is in the form of a buy and sell ticket.

20. A method, as claimed in claim 16, wherein:
said desired report is in the form of a client activity log.

21. A method, as claimed in claim 16, wherein:
said desired report is in the form of a trade audit report.

22. A method, as claimed in claim 13, further including the steps of:
inputting authentication data to gain authority to access the data processing system including a password, user ID, and system ID; and
verifying the authentication data to determine access to the data processing system.

23. A method, as claimed in claim 21, further including the step of:
creating an output in the form of a log-ins report reflective of log-ins made to the data processing system.

24. A method of processing and monitoring broker transaction data in the form of e-mail messages sent to a broker representative, said method comprising the steps of:
receiving an incoming e-mail message from a party requesting a trade of a security, the e-mail message being received on a computer linked to a website corresponding to a data processing system;
posting the received e-mail message to a main server computer, and recording the email message on a main database of the main computer;
posting the e-mail message on a user screen for availability by a branch manager;
signifying approval/rejection of the e-mail message by the branch manager;
posting the approved/rejected e-mail message to the main database of the main computer;
recording the status of the approved/rejected e-mail message in the main database;
posting the e-mail message on a user screen for availability by a broker representative for review by the broker representative; and
creating an output in the form of a compliance report reflective of rejected e-mail messages.

25. A method, as claimed in claim 24, wherein:
all posting steps are achieved by secure electronic transmission using encryption and decryption.

26. A method of processing and monitoring broker transaction data in the form of e-mail messages from a broker representative to a client, said method comprising the steps of:
creating and recording an e-mail message on a main database of a data processing system;
posting the e-mail message for review by a branch manager, said posting step including providing a user screen available by the branch manager;
signifying approval/rejection of the e-mail message by the branch manager entering data reflective of the approval/rejection;
posting the approved/rejected e-mail message on the main database;
recording the status of the approved/rejected e-mail message on the main database;
posting the e-mail message on a user screen for availability by the broker representative by the broker representative; and
creating an output in the form of a compliance report reflective of rejected e-mail messages.

27. A method, as claimed in claim 26, wherein:
all posting steps are achieved by secure electronic transmission using encryption and decryption.
